(19) United States
(12) Patent Application Publication
(10) Pub. No.: US 2026/0130427 A1
(43) Pub. Date: May 14, 2026

(54) HEATER ASSEMBLY AND AEROSOL GENERATING DEVICE COMPRISING THE SAME

(71) Applicant: KT&G CORPORATION, Daejeon (KR)

(72) Inventors: Jin Chul JUNG, Daejeon (KR); Jung Ho Kim, Seoul (KR); Sang Cheol Park, Suwon-si (KR); Jang Won Seo, Yongin-si (KR); Won Kyeong Lee, Guri-si (KR); Chul Ho Jang, Bucheon-si (KR)

(73) Assignee: KT&G CORPORATION, Daejeon (KR)

(21) Appl. No.: 19/322,904

(22) Filed: Sep. 9, 2025

(30) Foreign Application Priority Data
Nov. 14, 2024 (KR) 10-2024-0162276
Nov. 14, 2024 (KR) 10-2024-0162277
Mar. 18, 2025 (KR) 10-2025-0034895
Mar. 18, 2025 (KR) 10-2025-0034896

(51) Int. Cl. A24F 40/46; A24F 40/50; A24F 40/60; H05B 3/28

(52) U.S. Cl. CPC A24F 40/46; A24F 40/50; A24F 40/60; H05B 3/28; H05B 2203/003; H05B 2203/016

(57) ABSTRACT

A heater assembly for an aerosol generating device includes a supporter including an insertion space accommodating an aerosol generating article, a heater disposed on an inner surface of the supporter surrounding the insertion space, an insulator including an inner wall spaced apart by a certain distance from an outer surface of the supporter to surround the supporter, an outer wall spaced apart at least partially from the inner wall, and an insulation space in a vacuum state formed between the inner wall and the outer wall, and a pair of connectors electrically connected to the heater to supply power to the heater, wherein the supporter includes, in at least one region, a through hole that is opened to face the insertion space so that the pair of connectors are exposed to an outside of the supporter.

### CROSS-REFERENCE TO RELATED APPLICATIONS

This application is based on and claims priority under 35 U.S.C. § 119 to Korean Patent Application Nos. 10-2024-0162276 and 10-2024-0162277, filed on Nov. 14, 2024, and 10-2025-0034895 and 10-2025-0034896, filed on Mar. 18, 2025, in the Korean Intellectual Property Office, the disclosures of which are incorporated by reference herein in their entireties.

### BACKGROUND

1. Field

Various embodiments relate to a heater assembly and an aerosol generating device including the same, and more particularly, to a heater assembly with an improved structure and an aerosol generating device including the same.

2. Description of the Related Art

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes. Accordingly, research on heating-type aerosol generating devices has been actively conducted.

In heating-type aerosol generating devices, a heater for heating a cigarette is the most important component. Accordingly, various researches on the heater, such as the structure and control of the heater, have been conducted.

### SUMMARY

Designs of a heater for heating an aerosol generating article (this may be used in the same meaning as a ‘cigarette’) and peripheral components of the heater may have great significance in an aerosol generating device.

For example, the designs of the heater and the peripheral components may affect the heating efficiency of the aerosol generating article. In addition, the designs of the heater and the peripheral components may determine a degree to which heat generated by the heater is transferred to a user's hand gripping the aerosol generating device.

According to this, the heater and the peripheral components need to have more appropriate structures and arrangements. This may also be applied to a connector that supplies power to the heater to heat the heater.

Provided are a heater assembly with an improved structure and an aerosol generating device including the same.

The technical problems of the present disclosure are not limited to the above-described description, and other technical problems may be clearly understood by one of ordinary skill in the art from the embodiments to be described hereinafter.

Additional aspects will be set forth in part in the description which follows and, in part, will be apparent from the description, or may be learned by practice of the presented embodiments of the disclosure.

According to an embodiment, a heater assembly for an aerosol generating device may include a supporter including an insertion space accommodating an aerosol generating article, a heater disposed on an inner surface of the supporter surrounding the insertion space, an insulator including an inner wall spaced apart by a certain distance from an outer surface of the supporter to surround the supporter, an outer wall spaced apart at least partially from the inner wall, and an insulation space in a vacuum state formed between the inner wall and the outer wall, and a pair of connectors electrically connected to the heater to supply power to the heater, wherein the supporter includes, in at least one region, a through hole that is opened to face the insertion space so that the pair of connectors are exposed to an outside of the supporter.

According to an embodiment, an aerosol generating device may include a heater assembly according to an embodiment, an output unit configured to output information about a state of the aerosol generating device, and a control unit electrically connected to the output unit, wherein the control unit is configured to determine whether a supporter and a heater have been electrically connected to each other based on a change in electric characteristics of the heater, and, when it is determined that the supporter and the heater have been electrically connected to each other, provide a notification to a user through the output unit.

According to another embodiment, a heater assembly may include a supporter including an insertion space accommodating an aerosol generating article, a heater disposed on an inner surface of the supporter surrounding the insertion space, an insulator including an inner wall spaced apart by a certain distance from an outer surface of the supporter to surround the supporter, an outer wall spaced apart at least partially from the inner wall, and an insulation space in a vacuum state formed between the inner wall and the outer wall, and a pair of connectors electrically connected to the heater to supply power to the heater, wherein the pair of connectors are withdrawn between the supporter and the inner wall.

According to another embodiment, a separation space between the supporter and the inner wall of the insulator may be filled with air.

According to another embodiment, the separation space between the supporter and the inner wall of the insulator may be a movement passage of air.

The heater assembly according to another embodiment may further include an upper cover coupled to an upper side of the insulator and including an inflow passage of air, and a lower cover coupled to a lower side of the insulator and including a transfer passage of air, and air outside the heater assembly may sequentially pass through the inflow passage, the separation space, and the transfer passage to flow into one end of the aerosol generating article accommodated in the insertion space.

According to another embodiment, the lower cover may further include a groove accommodating one end of the aerosol generating article and a support disposed on a bottom surface of the groove to support an end surface of the aerosol generating article, and the end surface of the aerosol generating article accommodated in the groove and the bottom surface of the groove may be spaced apart from each other.

According to another embodiment, the heater may include a pattern by which one end and the other end are distinguished from each other, and the one end of the heater may be connected to one of the pair of connectors, and the other end of the heater may be connected to the other one of the pair of connectors.

According to another embodiment, the heater may be disposed to surround at least a part of the insertion space, and the one end of the heater and the other end of the heater may be disposed adjacent to each other and extend in parallel toward an upper side of the heater.

According to another embodiment, each of the pair of connectors may include a portion extending in a direction across a longitudinal direction of the insertion space.

The heater assembly according to another embodiment may further include an upper cover coupled to an upper side of the insulator, and the pair of connectors may be withdrawn between the supporter and the inner wall through an extra space between the supporter and the upper cover.

According to another embodiment, the supporter may include, in at least one region, a through hole that is opened to face the insertion space so that the pair of connectors are exposed to the outside of the supporter.

According to another embodiment, the through hole may be disposed in an upper region of the supporter.

According to another embodiment, one of the pair of connectors may extend in a first direction surrounding the supporter between the supporter and the inner wall, and the other one of the pair of connectors may extend in a second direction opposite to the first direction.

According to another embodiment, at least one of the pair of connectors may include a helical structure.

According to another embodiment, at least one of the pair of connectors may be disposed to surround an outer side of the supporter along the helical structure.

According to another embodiment, an aerosol generating device may include a heater assembly according to an embodiment, a housing including an internal space in which the heater assembly is disposed, a power supply for supplying power to the heater assembly, and a control unit for controlling the power supplied to the heater assembly.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an aerosol generating device according to an embodiment;

FIG. 2a illustrates an aerosol generating device according to an embodiment;

FIG. 2b illustrates an aerosol generating device according to an embodiment;

FIG. 3 illustrates an aerosol generating device according to an embodiment;

FIG. 4 is a cross-sectional view schematically illustrating the inside of an aerosol generating device according to an embodiment;

FIG. 5A is a perspective view of a heater assembly according to an embodiment;

FIG. 5B is an exploded perspective view of the heater assembly illustrated in FIG. 5A;

FIG. 6 is a cross-sectional view of the heater assembly illustrated in FIG. 5A taken along a cross-sectional line A-A′;

FIG. 7 is a perspective view illustrating an example of an internal structure of a heater assembly according to an embodiment;

FIG. 8 is a diagram illustrating a heater assembly to which the internal structure illustrated in FIG. 7 is applied and an aerosol generating device including the heater assembly;

FIG. 9 is a perspective view illustrating another example of an internal structure of a heater assembly according to an embodiment;

FIG. 10 is a cross-sectional view of a heater assembly to which the internal structure illustrated in FIG. 9 is applied;

FIG. 11 is a cross-sectional view of an example of a heater assembly according to another embodiment;

FIG. 12A is a cross-sectional view of another example of a heater assembly according to another embodiment;

FIG. 12B is a perspective view illustrating an internal structure of the heater assembly illustrated in FIG. 12A;

FIG. 13A is a cross-sectional view of a heater assembly according to another embodiment;

FIG. 13B is a perspective view illustrating an internal structure of the heater assembly illustrated in FIG. 13A; and

FIGS. 14A and 14B are each a perspective view illustrating another example of an internal structure of a heater assembly according to another embodiment.

### DETAILED DESCRIPTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted. With regard to the description of the drawings, similar reference numerals may be used to refer to similar or related elements.

In the following description, with respect to constituent elements used in the following description, the suffixes “module” and “unit” are used only in consideration of facilitation of description, and do not have mutually distinguished meanings or functions. As used herein, the suffix “module” or “unit” may include a unit implemented in hardware, software, or firmware, and may be used interchangeably with other terms, for example, “logic,” “logic block,” “part,” or “circuitry.” A “module” or a “unit” may be a single integral component, or a minimum unit or part thereof, adapted to perform one or more functions. For example, the “module” or the “unit” may be implemented in the form of an application-specific integrated circuit (ASIC).

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and spirit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Embodiments as set forth herein may be implemented as software including one or more instructions that are stored in a storage medium (e.g., a memory 17) that is readable by a machine (e.g., the aerosol-generating device 1). For example, a processor (e.g., the controller 12) of the machine (e.g., the aerosol-generating device 1) may invoke at least one of the one or more instructions stored in the storage medium, and may execute the same. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

In the present disclosure, the directions of the aerosol-generating device 1 may be defined based on the orthogonal coordinate system. In the orthogonal coordinate system, the x-axis direction may be defined as a leftward-rightward direction of the aerosol-generating device 1. The y-axis direction may be defined as a forward-backward direction of the aerosol-generating device 1. The z-axis direction may be defined as an upward-downward direction of the aerosol-generating device 1.

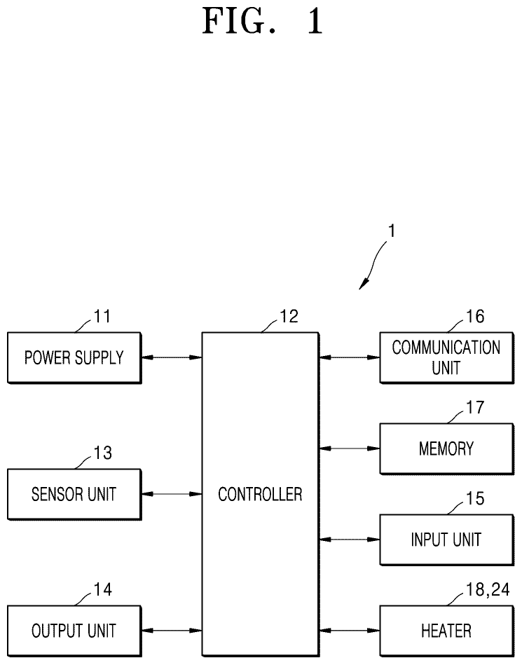

FIG. 1 is a block diagram of an aerosol-generating device according to an embodiment.

According to one embodiment, the aerosol-generating device 1 may include a power supply 11, a controller 12, a sensor unit 13, an output unit 14, an input unit 15, a communication unit 16, a memory 17, and/or a heater 18 and 24. However, the components included in the aerosol-generating device 1 are not limited to those shown in FIG. 1. That is, it will be understood by those skilled in the art related to the present embodiment that some of the components shown in FIG. 1 may be omitted or new components may be further included depending on the design of the aerosol-generating device 1.

According to one embodiment, the sensor unit 13 may detect the state of the aerosol-generating device 1 or the state of the surroundings of the aerosol-generating device 1, and may transmit the detected information to the controller 12. For example, the sensor unit 13 may include a temperature sensor, a puff sensor, an insertion detection sensor, a reuse detection sensor, an overly moist state detection sensor, a cigarette identification sensor, a cartridge detection sensor, a cap detection sensor, and/or a movement detection sensor. Meanwhile, the sensor unit 13 may further include various sensors, such as a liquid residual quantity sensor for detecting the residual quantity of liquid in the cartridge and an immersion sensor for detecting immersion of the aerosol-generating device 1.

According to one embodiment, the temperature sensor may detect a temperature to which the heater 18 and 24 is heated. The aerosol-generating device 1 may include a separate temperature sensor for detecting the temperature of the heater 18 and 24, or the heater 18 and 24 itself may serve as a temperature sensor. In an example, the temperature sensor may be used to measure impedance for the heater 18. The impedance for the heater 18 may correlate with the temperature of the heater 18. The temperature sensor may measure current and/or voltage applied to the heater 18 (or an induction coil). The impedance for the heater 18 may be obtained based on the measured current and/or voltage. The controller 12 may estimate the temperature of the heater 18 based on the obtained impedance.

In an example, the temperature sensor may include a resistance element (e.g., a thermistor), the resistance value of which varies in response to changes in the temperature of the heater 18 and 24. The temperature sensor may output a signal corresponding to the resistance value of the resistance element, and the controller 12 may determine the temperature of the heater 18 and 24 and/or a change in the temperature of the heater 18 and 24 based on the signal corresponding to the resistance value.

In another example, the temperature sensor may include a sensor that detects the resistance value of the heater 18 and 24. The temperature sensor may output a signal corresponding to the resistance value of the heater 18 and 24, and the controller 12 may determine the temperature of the heater 18 and 24 and/or a change in the temperature of the heater 18 and 24 based on the signal corresponding to the resistance value.

According to one embodiment, the temperature sensor may detect the temperature of the power supply 11. The temperature sensor may be disposed adjacent to the power supply 11. For example, the temperature sensor may be attached to one surface of the power supply 11 (e.g., a battery) and/or may be mounted on one surface of a printed circuit board. In an example, the aerosol-generating device 1 may include a power supply protection circuit module (PCM), and the temperature sensor may be disposed adjacent to the power supply 11 together with the power supply protection circuit module.

According to one embodiment, the temperature sensor may be disposed in a housing (not shown) of the aerosol-generating device 1 to detect the internal temperature of the housing (not shown).

According to one embodiment, the puff sensor may detect a user's puff.

In an example, the puff sensor may include a pressure sensor. The pressure sensor may output a signal corresponding to the internal pressure of the aerosol-generating device 1, and the controller 12 may determine the user's puff based on the signal corresponding to the internal pressure. Here, the internal pressure of the aerosol-generating device 1 may correspond to the pressure of an airflow path through which gas flows. The puff sensor may be disposed corresponding to the airflow path through which gas flows in the aerosol-generating device 1.

In another example, the puff sensor may include a temperature sensor. When the user's puff occurs, temperature drop may temporarily occur in the airflow path, a space into which an aerosol-generating article is inserted (hereinafter referred to as an “insertion space”), and the heater 18 and 24. The controller 12 may determine the user's puff based on a signal corresponding to the temperature of the airflow path output from the temperature sensor.

In still another example, the puff sensor may include both a pressure sensor and a temperature sensor. In this case, the temperature sensor may measure temperature used to calibrate the internal pressure measured by the pressure sensor. In one example, the puff sensor may calibrate a signal corresponding to the internal pressure based on the temperature measured by the temperature sensor, and may output the calibrated signal. In another example, the puff sensor may output a signal corresponding to the temperature measured by the temperature sensor and a signal corresponding to the internal pressure measured by the puff sensor. In this case, the controller 12 may receive the signals, and may calibrate the signal corresponding to the internal pressure based on the signal corresponding to the temperature.

In still another example, the puff sensor may include a capacitance sensor. The capacitance sensor may also be called a cap sensor or a capacitive sensor. When the user's puff occurs, a temperature change and/or aerosol flow may occur in the insertion space of the aerosol-generating article, and accordingly, a dielectric constant in the insertion space may change. The controller 12 may determine the user's puff based on a signal corresponding to the dielectric constant in the insertion space output from the capacitance sensor.

The puff sensor is not limited to the examples described above, and may be implemented as various sensors for detecting the user's puff.

According to one embodiment, the insertion detection sensor may detect insertion and/or removal of the aerosol-generating article. The insertion detection sensor may be mounted adjacent to the insertion space. In addition, the insertion detection sensor may include any combination of the examples described above.

In an example, the insertion detection sensor may include a capacitance sensor. The capacitance sensor may include at least one conductor, and the at least one conductor may be disposed adjacent to the insertion space. When the aerosol-generating article is inserted into or removed from the insertion space, capacitance around the conductor may change. The controller 12 may determine insertion and/or removal of the aerosol-generating article based on a signal corresponding to the dielectric constant in the insertion space output from the capacitance sensor.

In another example, the insertion detection sensor may include an inductive sensor. The inductive sensor may include at least one coil, and the at least one coil may be disposed adjacent to the insertion space. If the aerosol-generating article (e.g., a wrapper of the aerosol-generating article) includes a conductor, when the aerosol-generating article is inserted into or removed from the insertion space, a change in magnetic field may occur around the coil through which current flows. The controller 12 may determine insertion and/or removal of the aerosol-generating article including a conductor based on the characteristics of the current output from or detected by the inductive sensor (e.g., frequency of alternating current, a current value, a voltage value, an inductance value, and an impedance value). Alternatively, a susceptor SUS or the like may be included in the aerosol-generating article (e.g., a medium portion of the aerosol-generating article). In this case, a change in magnetic field may also occur around the coil based on insertion or removal of the susceptor or the like into or from the insertion space, and the controller 12 may determine insertion and/or removal of the aerosol-generating article based on the characteristics of the current of the inductive sensor.

The insertion detection sensor is not limited to the examples described above, and may be implemented as various sensors (e.g., a proximity sensor) for detecting insertion and/or removal of the aerosol-generating article. In addition, the insertion detection sensor may include any combination of the examples described above. According to one embodiment, the insertion detection sensor may include a switch or the like for detecting pressing by the aerosol-generating article.

According to one embodiment, the reuse detection sensor may detect whether the aerosol-generating article is being reused. In an example, the reuse detection sensor may be a color sensor for detecting the color of the aerosol-generating article. If the aerosol-generating article is used by the user, a change in the color of a portion of the wrapper may occur due to the generated aerosol or heating. The color sensor may output a signal corresponding to an optical characteristic (e.g., wavelength of light) corresponding to the color of the wrapper based on the light reflected from the wrapper. When a change in the color of a portion of the wrapper is detected, the controller 12 may determine that the aerosol-generating article inserted into the insertion space has already been used.

According to one embodiment, the overly moist state detection sensor may detect whether the aerosol-generating article is in an overly moist state. For example, the overly moist state detection sensor may include a capacitance sensor. The capacitance sensor may include at least one conductor disposed adjacent to the insertion space. The controller 12 may determine whether the aerosol-generating article is in an overly moist state based on the level of a signal corresponding to the dielectric constant or the like output from the capacitance sensor. In an example, the controller 12 may check a level range within which the level of the signal is included based on a look-up table, and may determine the moisture content of the aerosol-generating article based on the checked level range.

According to one embodiment, the cigarette identification sensor may detect whether the aerosol-generating article is authentic and/or may detect the type of the aerosol-generating article.

In an example, the cigarette identification sensor may include an optical sensor for detecting an identification material (or an identification mark) located on the outer surface (e.g., the wrapper) of the aerosol-generating article. The optical sensor may radiate light toward the identification material (or the identification mark) of the aerosol-generating article, and may detect whether the aerosol-generating article is authentic and/or may detect the type of the aerosol-generating article based on the reflected light. For example, the identification material may include a material (i.e., a luminous material) that emits light of a specific wavelength band based on the light radiated thereto. The controller 12 may determine whether the aerosol-generating article is authentic and/or may determine the type of the aerosol-generating article based on the range of the wavelength.

In another example, the cigarette identification sensor may include a capacitance sensor. The dielectric constant in the insertion space may vary depending on the type of the aerosol-generating article inserted into the insertion space. The controller 12 may determine whether the aerosol-generating article is authentic and/or may determine the type of the aerosol-generating article based on a signal corresponding to the dielectric constant or the like in the insertion space output from the capacitance sensor.

In still another example, the cigarette identification sensor may include an inductive sensor. If a conductor is included in the wrapper and/or inner portion (e.g., the medium portion) of the aerosol-generating article inserted into the insertion space, when the aerosol-generating article is inserted into the insertion space, the characteristics of the current detected by the inductive sensor (e.g., frequency of alternating current, a current value, a voltage value, an inductance value, and an impedance value) may vary depending on the type of the aerosol-generating article inserted into the insertion space. The controller 12 may determine whether the inserted aerosol-generating article is authentic and/or may determine the type of the inserted aerosol-generating article based on the characteristics of the current output from or detected by the inductive sensor.

The cigarette identification sensor is not limited to the examples described above, and may be implemented as various sensors for detecting whether the aerosol-generating article is authentic and/or detecting the type of the aerosol-generating article. In addition, the cigarette identification sensor may include any combination of the examples described above.

According to one embodiment, the cartridge detection sensor may detect mounting and/or removal of the cartridge. For example, the cartridge detection sensor may include an inductive sensor, a capacitance sensor, a resistance sensor, a Hall sensor (Hall IC), and/or an optical sensor.

According to one embodiment, the cap detection sensor may detect mounting and/or removal of the cap. For example, the cap detection sensor may include an inductive sensor, a capacitance sensor, a resistance sensor, a contact sensor, a Hall sensor (Hall IC), and/or an optical sensor. The cap may cover at least a portion of the cartridge mounted in or inserted into the aerosol-generating device 1 or may cover at least a portion of the housing of the aerosol-generating device 1. When the cap is mounted in or removed from the housing, the cap detection sensor may output a signal corresponding to mounting or removal, and the controller 12 may determine mounting or removal of the cap based on the signal corresponding to mounting or removal.

According to one embodiment, the movement detection sensor may detect movement of the aerosol-generating device 1. The movement detection sensor may be implemented as at least one of an acceleration sensor or a gyro sensor.

According to one embodiment, the sensor unit 13 may further include at least one of a humidity sensor, an air pressure sensor, a magnetic sensor, a position sensor (global positioning system (GPS)), or a proximity sensor in addition to the sensors described above. The functions of the sensors can be intuitively deduced by those skilled in the art from the names thereof, and thus detailed descriptions thereof may be omitted.

According to one embodiment, the output unit 14 may output information about the state of the aerosol-generating device 1 to provide the same to the user. The output unit 14 may include, but is not limited to, a display, a haptic unit, and/or a sound output unit. For example, information about the aerosol-generating device 1 may include a charging/discharging state of the power supply 11 of the aerosol-generating device 1, a preheating state of the heater 18 and 24, an insertion/removal state of the aerosol-generating article and/or the cartridge, a mounting/removal state of the cap, or a state in which the use of the aerosol-generating device 1 is restricted (e.g., detection of an abnormal object). The display may visually provide the information about the state of the aerosol-generating device 1 to the user. For example, the display may include a light-emitting diode (LED), a liquid crystal display panel (LCD), and an organic light-emitting diode panel (OLED). If the display includes a touchpad, the display may also be used as the input unit 15. The haptic unit may haptically provide the information about the aerosol-generating device 1 to the user. For example, the haptic unit may include a vibration motor, a piezoelectric element, and an electrical stimulation device. The sound output unit may audibly provide the information about the aerosol-generating device 1 to the user. For example, the sound output unit may convert an electrical signal into an acoustic signal and may output the acoustic signal to the outside.

According to one embodiment, the power supply 11 may supply power used for operation of the aerosol-generating device 1. The power supply 11 may include one or more batteries. The power supply 11 may supply power so that the heater 18 and 24 is heated. In addition, the power supply 11 may supply power necessary for operation of the other components included in the aerosol-generating device 1, such as the controller 12, the sensor unit 13, the output unit 14, the input unit 15, the communication unit 16, and the memory 17. The power supply 11 may be a rechargeable battery or a disposable battery. For example, the power supply 11 may be a lithium polymer (LiPoly) battery without being limited thereto. The power supply 11 may be a replaceable (separation-type) battery (hereinafter referred to as a “removable battery”). The removable battery may be mounted in a battery accommodation portion provided in the aerosol-generating device 1 or may be removed from the battery accommodation portion. The removable battery may be charged in a wired and/or wireless manner.

According to one embodiment, the heater 18 and 24 may receive power from the power supply 11 to heat the aerosol-generating article (e.g., a cigarette) and/or a medium and/or an aerosol-generating substance in the cartridge. The aerosol-generating device 1 may include a heater 18 for heating the aerosol-generating article and/or a cartridge heater 24 for heating the cartridge (i.e., a solid and/or liquid medium).

According to one embodiment, the heater 18 and 24 may be an electro-resistive heater. For example, the electro-resistive heater may include an electrically resistive material such as a metal or a metal alloy including titanium, zirconium, tantalum, platinum, nickel, cobalt, chromium, hafnium, niobium, molybdenum, tungsten, tin, gallium, manganese, iron, copper, stainless steel, and nichrome. The electro-resistive heater may be implemented as a metal wire, a metal plate having an electrically conductive track disposed thereon, or a ceramic heating element.

According to one embodiment, the heater 18 and 24 may be an induction heater. For example, the induction heater may include a susceptor that generates heat through a magnetic field. A magnetic field may be generated by an induction coil by alternating current flowing through the induction coil. The magnetic field may pass through the heater, and an eddy current may be generated in the susceptor. The susceptor may be heated based on generation of the eddy current. According to one embodiment, the susceptor may be included in the inner portion (e.g., the medium portion) of the aerosol-generating article. In this case, the susceptor included in the inner portion of the aerosol-generating article may also be heated by the induction coil.

The heater 18 and 24 is not limited to the examples described above, and may include or be replaced with various heating methods, structures, and components for heating the aerosol-generating article and/or the cartridge.

According to one embodiment, the input unit 15 may receive information input from the user. For example, the input unit 15 may include a touch panel, a button, a keypad, a dome switch, a jog wheel, and a jog switch.

According to one embodiment, the memory 17 may be hardware storing various pieces of data processed in the aerosol-generating device 1. The memory 17 may store data processed and to be processed by the controller 12. For example, the memory 17 may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. For example, the memory 17 may store data on an operation time of the aerosol-generating device 1, the maximum number of puffs, the current number of puffs, at least one temperature profile, and the user's smoking pattern.

According to one embodiment, the communication unit 16 may include at least one component for communication with other electronic devices (e.g., a portable electronic device). For example, the communication unit 16 may include a Bluetooth communication unit, a Bluetooth low energy (BLE) communication unit, a near-field communication unit, a wireless local area network (WLAN) communication unit, a Zigbee communication unit, an infrared data association (IrDA) communication unit, a Wi-Fi direct (WFD) communication unit, an ultra-wideband (UWB) communication unit, an Ant+ communication unit, a cellular network communication unit, an Internet communication unit, and a computer network (e.g., LAN or WAN) communication unit.

According to one embodiment, the controller 12 may control the overall operation of the aerosol-generating device 1. For example, the controller 12 may include at least one processor. The controller 12 may be implemented as an array of a plurality of logic gates or may be implemented as a combination of a general-purpose microcontroller unit (MCU) (or a microprocessor) and a memory in which a program executable by the MCU is stored. It will be understood by those skilled in the art that the controller may also be implemented as other forms of hardware.

According to one embodiment, the controller 12 may control the supply of power from the power supply 11 to the heater 18 and 24 to control the temperature of the heater 18 and 24. The controller 12 may control the temperature of the heater 18 and 24 and/or power supplied to the heater 18 and 24 based on the temperature of the heater 18 and 24 detected by the temperature sensor (e.g., the sensor unit 13). The controller 12 may control the temperature of the heater 18 and 24 and/or power supplied to the heater 18 and 24 based on the temperature profile and/or the power profile stored in the memory 17.

According to one embodiment, the controller 12 may control a power conversion circuit (not shown) electrically connected to the heater 18 and 24 and the power supply 11 to control power (e.g., voltage and/or current) supplied to the heater 18 and 24. For example, the power conversion circuit may include a DC/DC converter (e.g., a buck converter, a buck-boost converter, a boost converter, or a Zener diode) that converts power to be supplied to the heater 18 and 24 and a DC/AC converter (e.g., an inverter) that converts power to be supplied to the induction coil (not shown). The DC/AC converter may be implemented as a full-bridge circuit or a half-bridge circuit including a plurality of switching elements. For example, the power conversion circuit may include at least one switching element, such as a bipolar junction transistor (BJT) or a field effect transistor (FET).

According to one embodiment, the controller 12 may control the frequency and/or duty ratio of a current pulse input to at least one switching element of the power conversion circuit (not shown) to control the current and/or the voltage supplied to the heater 18 and 24. The duty ratio for the on/off operation of the switching element may correspond to a ratio of the voltage output from the power conversion circuit to the voltage output from the power supply 11.

According to one embodiment, the controller 12 may control power supplied to the heater 18 and 24 using at least one of a pulse width modulation (PWM) scheme or a proportional-integral-differential (PID) scheme. For example, the controller 12 may perform control using the PWM scheme such that a current pulse having a predetermined frequency and a predetermined duty ratio is supplied to the heater 18 and 24. The controller 12 may control the frequency and duty ratio of the current pulse to control power supplied to the heater 18 and 24. For example, the controller 12 may determine, based on the temperature profile, a target temperature to be controlled. The controller 12 may control power supplied to the heater 18 and 24 using the PID scheme, which is a feedback control scheme using a difference value between the temperature of the heater 18 and the target temperature, a value obtained by integrating the difference value with respect to time, and a value obtained by differentiating the difference value with respect to time.

According to one embodiment, the controller 12 may determine, based on the power profile, target power to be controlled. The controller 12 may control power supplied to the heater 18 and 24 so as to correspond to the preset target power over time.

According to one embodiment, the controller 12 may detect power supplied to the heater 18 and 24 to determine the user's puff. In more detail, the controller 12 may control power supplied to the heater 18 and 24 using the proportional-integral-differential (PID) scheme. When the user's puff occurs, temperature drop may temporarily occur in a space into which the aerosol-generating article is inserted (hereinafter referred to as an insertion space) and the heater 18 and 24. Accordingly, the power (or the current) supplied to the heater 18 and 24 may change during control of the power using the PID scheme. The controller 12 may determine the user's puff based on the change in the power controlled.

According to one embodiment, the controller 12 may prevent the heater 18 and 24 from overheating. For example, the controller 12 may control, based on the temperature of the heater 18 and 24 exceeding a preset limit temperature, operation of the power conversion circuit such that the amount of power supplied to the heater 18 and 24 is reduced or the supply of power to the heater 18 and 24 is interrupted.

According to one embodiment, the controller 12 may control charging/discharging of the power supply 11. For example, the controller 12 may check the temperature of the power supply 11 using the temperature sensor (e.g., the sensor unit 13). If the temperature of the power supply 11 is equal to or higher than a first limit temperature, the controller 12 may interrupt charging of the power supply 11. If the temperature of the power supply 11 is equal to or higher than a second limit temperature, the controller 12 may interrupt use of the power stored in the power supply 11 (e.g., discharging). The controller 12 may calculate the remaining amount of the power stored in the power supply 11. For example, the controller 12 may calculate the remaining capacity of the power supply 11 based on a voltage and/or current detection value of the power supply 11.

According to one embodiment, the controller 12 may control the supply of power to the heater 18 and 24 based on a result of the detection by the sensor unit 13.

According to one embodiment, the controller 12 may control the supply of power to the heater 18 and 24 based on insertion and/or removal of the aerosol-generating article into and/or from the insertion space. For example, upon determining that the aerosol-generating article has been inserted into the insertion space using the insertion detection sensor (e.g., the sensor unit 13), the controller 12 may perform control such that power is supplied to the heater 18 and 24. Upon determining that the aerosol-generating article has been removed from the insertion space using the insertion detection sensor (e.g., the sensor unit 13), the controller 12 may interrupt the supply of power to the heater 18 and 24. The controller 12 may determine that the aerosol-generating article has been removed from the insertion space when the temperature of the heater 18 and 24 is equal to or higher than a limit temperature or when the temperature change slope of the heater 18 and 24 is equal to or greater than a preset slope.

According to one embodiment, the controller 12 may control, based on the state of the aerosol-generating article, a power supply time and/or the amount of power supplied to the heater 18 and 24. For example, upon determining that the aerosol-generating article is in an overly moist state using the overly moist state detection sensor (e.g., the sensor unit 13), the controller 12 may increase a time during which power is supplied to the heater 18 and 24 (e.g., a preheating time).

According to one embodiment, the controller 12 may control the supply of power to the heater 18 and 24 based on whether the aerosol-generating article is being reused. For example, upon determining that the aerosol-generating article has already been used, the controller 12 may interrupt the supply of power to the heater 18 and 24.

According to one embodiment, the controller 12 may control the supply of power to the heater 18 and 24 based on whether the cartridge has been coupled and/or removed. For example, upon determining that the cartridge has been removed using the cartridge detection sensor (e.g., the sensor unit 13), the controller 12 may interrupt the supply of power to the heater 18 or 24 or may perform control such that power is not supplied to the heater 18 and 24.

According to one embodiment, the controller 12 may control the supply of power to the heater 18 and 24 based on whether the aerosol-generating substance in the cartridge has been exhausted. For example, upon determining that the temperature of the heater 18 and 24 exceeds a limit temperature during preheating of the heater 18 and 24 (i.e., in the preheating section), the controller 12 may determine that the aerosol-generating substance in the cartridge has been exhausted. Upon determining that the aerosol-generating substance in the cartridge has been exhausted, the controller 12 may interrupt the supply of power to the heater 18 and 24.

According to one embodiment, the controller 12 may control the supply of power to the heater 18 and 24 based on whether use of the cartridge is possible. For example, upon determining, based on data stored in the memory 17, that the current number of puffs is equal to or greater than the maximum number of puffs set for the cartridge, the controller 12 may determine that use of the cartridge is impossible. Alternatively, when a total time period during which the heater 18 and 24 is heated is equal to or longer than a preset maximum time period or when the total amount of power supplied to the heater 18 and 24 is equal to or greater than a preset maximum amount of power, the controller 12 may determine that use of the cartridge is impossible. In this case, the controller 12 may interrupt the supply of power to the heater 18 or 24 or may perform control such that power is not supplied to the heater 18 and 24.

According to one embodiment, the controller 12 may control the supply of power to the heater 18 and 24 based on the user's puff. For example, the controller 12 may determine whether a puff occurs and/or the intensity of a puff using the puff sensor (e.g., the sensor unit 13). When the number of puffs reaches a preset maximum number of puffs and/or when no puff is detected for a preset time period or longer, the controller 12 may interrupt the supply of power to the heater 18 and 24. When a puff is detected, the controller 12 may control the supply of power to the heater 18 and 24.

According to one embodiment, the controller 12 may control the supply of power to the heater 18 and 24 based on whether the aerosol-generating article (or the cartridge) is authentic and/or the type of the aerosol-generating article (or the cartridge). For example, the controller 12 may determine whether the aerosol-generating article is authentic and/or may determine the type of the aerosol-generating article using the cigarette identification sensor (e.g., the sensor unit 13). In an example, upon determining that the aerosol-generating article (or the cartridge) is inauthentic, the controller 12 may interrupt the supply of power to the heater 18 and 24. Upon determining that the aerosol-generating article (or the cartridge) is authentic, the controller 12 may control (e.g., commence) the supply of power to the heater 18 and 24. In another example, the controller 12 may control the supply of power to the heater 18 and 24 differently depending on the type of the aerosol-generating article (or the cartridge). In more detail, upon determining that the aerosol-generating article (or the cartridge) is a first aerosol-generating article (or a first cartridge), the controller 12 may control the temperature of the heater 18 and 24 and/or power based on a first temperature profile (or a first power profile), and upon determining that the aerosol-generating article (or the cartridge) is a second aerosol-generating article (or a second cartridge), the controller 12 may control the temperature of the heater 18 and 24 and/or power based on a second temperature profile (or a second power profile).

According to one embodiment, the controller 12 may control the output unit 14 based on a result of detection by the sensor unit 13. For example, when the number of puffs counted using the puff sensor (e.g., the sensor unit 13) reaches a preset number, the controller 12 may control the output unit 14 to visually, haptically, and/or audibly provide information that operation of the aerosol-generating device 1 will end soon. For example, the controller 12 may control the output unit 14 to visually, haptically, and/or audibly provide information about the temperature of the heater 18 and 24.

According to one embodiment, based on occurrence of a predetermined event, the controller 12 may store a history of the corresponding event in the memory 17 and may update the history. For example, the event may include events performed in the aerosol-generating device 1, such as detection of insertion of the aerosol-generating article, commencement of heating of the aerosol-generating article, detection of puff, termination of puff, detection of overheating of the heater 18 and 24, detection of application of overvoltage to the heater 18 and 24, termination of heating of the aerosol-generating article, on/off operation of the aerosol-generating device 1, commencement of charging of the power supply 11, detection of overcharging of the power supply 11, and termination of charging of the power supply 11. For example, the history of the event may include the occurrence date and time of the event and log data corresponding to the event. For example, when the predetermined event is detection of insertion of the aerosol-generating article, the log data corresponding to the event may include data on a value detected by the insertion detection sensor (e.g., the sensor unit 13). For example, when the predetermined event is detection of overheating of the heater 18 and 24, the log data corresponding to the event may include data on the temperature of the heater 18 and 24, the voltage applied to the heater 18 and 24, and the current flowing through the heater 18 and 24.

According to one embodiment, the controller 12 may control the communication unit 16 to form a communication link with an external device such as a user's mobile terminal.

According to one embodiment, upon receiving data on authentication from an external device via the communication link, the controller 12 may release restriction on use of at least one function (e.g., a heating function) of the aerosol-generating device 1. For example, the data on authentication may include the user's birthday, an identification number uniquely identifying the user, and whether authentication is completed by the user.

According to one embodiment, the controller 12 may transmit data on the state of the aerosol-generating device 1 (e.g., remaining capacity of the power supply 11 and operation mode) to the external device via the communication link. The transmitted data may be output through a display or the like of the external device.

According to one embodiment, upon receiving a request to search for the location of the aerosol-generating device 1 from the external device via the communication link, the controller 12 may control the output unit 14 to perform an operation corresponding to location search. For example, the controller 12 may perform control such that the haptic unit generates vibration or the display outputs objects corresponding to location search and termination of search.

According to one embodiment, upon receiving firmware data from the external device via the communication link, the controller 12 may perform firmware update.

According to one embodiment, the controller 12 may transmit data on a value detected by the at least one sensor unit 13 to an external server (not shown) via the communication link, and may receive, from the server, and store a learning model generated by learning the detected value through machine learning such as deep learning. The controller 12 may perform the operation of determining the user's puff pattern and the operation of generating the temperature profile using the learning model received from the server.

Although not shown in FIG. 1, the aerosol-generating device 1 may further include a power supply protection circuit. The power supply protection circuit may include at least one switching element, and may block an electric path to the power supply 11 in response to overcharging and/or overdischarging of the power supply 11. The aerosol-generating device 1 may further include a connection interface such as a universal serial bus (USB) interface, and may be connected to other external devices through the connection interface to transmit and receive information or charge the power supply 11.

The aerosol-generating article mentioned in the present disclosure may include at least one aerosol-generating rod (e.g., a medium portion) and at least one filter rod. The heater 18 may be disposed to correspond to the at least one aerosol-generating rod, and may be designed differently depending on the arrangement order and/or positions of the aerosol-generating rod and the filter rod. The aerosol-generating rod may contain at least one of nicotine, an aerosol-generating substance, and an additive. For example, the aerosol-generating substance may include glycerin (e.g., vegetable glycerin (VG)) and/or propylene glycol (PG) and may also include various other substances. For example, the additive may include a flavoring agent and/or an organic acid and may also include various other substances. For example, the aerosol-generating rod may include an aerosol-generating substrate (e.g., a sheet) impregnated with a liquid non-tobacco substance (e.g., an aerosol-generating substance and/or nicotine) and/or may contain a solid tobacco substance (e.g., leaf tobacco and reconstituted tobacco). The tobacco substance may be contained in the aerosol-generating rod in various forms, such as shredded tobacco, granules, and powder. According to one embodiment, the additive of the aerosol-generating rod may include an alkaline substance. Based on the alkaline substance, nicotine contained in the tobacco substance in the aerosol-generating rod may have an alkaline pH (e.g., pH 7.0 or higher). In this case, freebase nicotine may be released from the aerosol-generating rod even at a low temperature. According to one embodiment, the aerosol-generating rod may include two or more aerosol-generating rods, each of which may contain a tobacco substance and/or a non-tobacco substance. Meanwhile, although not shown, the at least one aerosol-generating rod and the at least one filter rod may individually and/or integrally be wrapped by at least one wrapper. In the present disclosure, the aerosol-generating article may be referred to as a stick.

The cartridge mentioned in the present disclosure may contain an aerosol-generating substance having any one state among a liquid state, a solid state, a gaseous state, and a gel state. The aerosol-generating substance may include a liquid composition. For example, the liquid composition may be a liquid containing a tobacco-containing substance including a volatile tobacco flavor component or may be a liquid containing a non-tobacco substance. Meanwhile, the cartridge may include a storage part that contains the aerosol-generating substance and/or a liquid delivery part that is impregnated with (contains) the aerosol-generating substance. For example, the liquid delivery part may include a wick formed of, e.g., cotton fiber, ceramic fiber, glass fiber, or porous ceramic. The cartridge heater 24 may be included in the cartridge in a coil-shaped structure surrounding (or wound around) the liquid delivery part or a structure contacting one side of the liquid delivery part. Alternatively, the cartridge heater 24 may be included in the aerosol-generating device 1, which is removable from the cartridge.

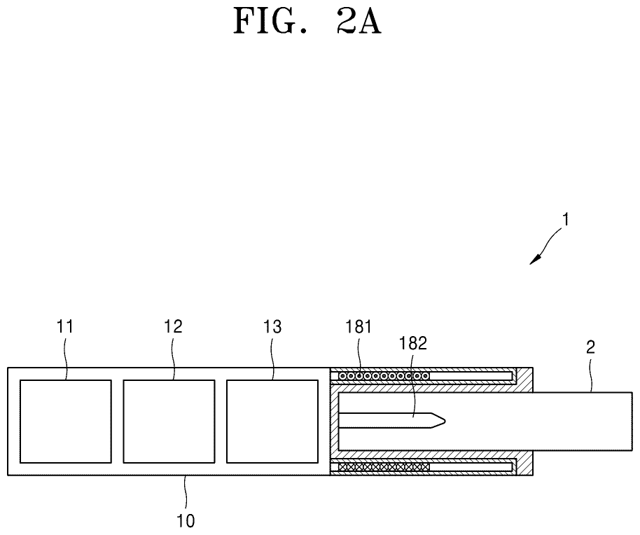

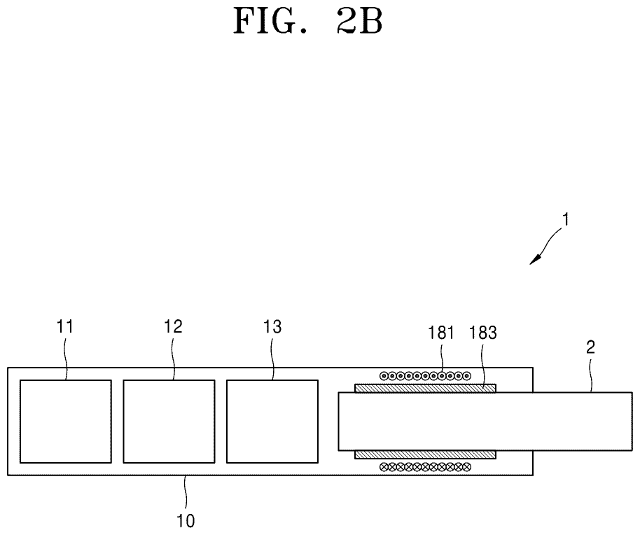

FIG. 2a shows an aerosol-generating device 1 according to an embodiment. FIG. 2b shows an aerosol-generating device 1 according to an embodiment.

According to one embodiment, the aerosol-generating device 1 may include a housing 10, a power supply 11, a controller 12, a sensor unit 13, and/or a heater 182 and 183 (e.g., the heater 18 in FIG. 1). However, it will be understood by those skilled in the art related to the present embodiment that the components included in the aerosol-generating device 1 are not limited to those shown in FIG. 2a or FIG. 2b and that some of the components may be omitted or new components may be further included. The aerosol-generating device 1 shown in FIG. 2a may be referred to as an “internal heating-type” aerosol-generating device that heats the inner side of an aerosol-generating article 2. The aerosol-generating device 1 shown in FIG. 2b may be referred to as an “external heating-type” aerosol-generating device that heats the outer side of the aerosol-generating article 2. In the drawings below, a description of configurations identical to those shown in FIG. 1 will be omitted.

According to one embodiment, the housing 10 may provide a space that is open upwardly to allow the aerosol-generating article 2 to be inserted thereinto. In the present disclosure, the space that is open upwardly may be referred to as an insertion space. The insertion space may be formed so as to be depressed in the housing 10 to a predetermined depth so that at least a portion of the aerosol-generating article 2 may be inserted thereinto. The depth of the insertion space may be equal to or greater than the length of a region of the aerosol-generating article 2 in which an aerosol-generating substance and/or a medium is contained. The lower end of the aerosol-generating article 2 may be inserted into the housing 10, and the upper end of the aerosol-generating article 2 may protrude outside the housing 10. A user may inhale an aerosol while holding the externally exposed upper end of the aerosol-generating article 2 in the mouth.

According to one embodiment, the heater 182 and 183 may heat the aerosol-generating article 2.

Referring to FIG. 2a, the heater 182 may be an internal heating-type heater.

According to one embodiment, the internal heating-type heater may be elongated upwardly in the space into which the aerosol-generating article 2 is inserted (i.e., the insertion space). For example, as shown in the drawings, the internal heating-type heater may include a rod-shaped or needle-shaped heating element. Alternatively, the internal heating-type heater may include various other heating elements, such as a tubular heating element or a plate-shaped heating element. The internal heating-type heater may be inserted through the lower portion of the aerosol-generating article 2.

According to one embodiment, the internal heating-type heater may include an electro-resistive heater and/or an induction heater.

For example, the electro-resistive heater may include an electro-resistive material, which is provided on the inner side (e.g., in the cavity or on the inner surface) or outer side (e.g., on the outer surface) thereof, and may generate heat as current flows through the electro-resistive material. In this case, the electro-resistive heater may be electrically connected to the power supply 11, and may directly generate heat using current received from the power supply 11. Meanwhile, an induction coil 181 may be omitt ed.

For example, in the case of an induction heater, the aerosol-generating device 1 may include an induction coil 181 surrounding at least a portion of the internal heating-type heater (e.g., disposed outside the heater so as to correspond to the length of at least a portion of the heater). In this case, a magnetic flux concentrator may be further provided outside the induction coil 181 in order to increase efficiency of induction heating. The induction heater may include a susceptor, and may generate heat based on a magnetic field generated by the induction coil 181. According to one embodiment, the induction heater (e.g., the susceptor) (or a heater module including the same) may be disposed to be removable from the housing 10.

According to one embodiment, the heater 182 may be a multi-heater. The multi-heater may include a first heater and a second heater, and may be inserted into the aerosol-generating article 2. The first heater and the second heater may be disposed side by side in the longitudinal direction. The first heater and the second heater may operate as an electro-resistive heater and/or an induction heater, and may be heated sequentially or simultaneously. In this case, the first heater and the second heater may be disposed at positions corresponding to the positions of two or more aerosol-generating rods in the longitudinal direction, respectively. Alternatively, the first heater and the second heater may be disposed at positions corresponding to the positions of a first portion and a second portion of one aerosol-generating rod in the longitudinal direction, respectively. Meanwhile, if the heater 182 is an induction heater, the aerosol-generating device 1 may include a first induction coil and a second induction coil, and the first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 182 in the longitudinal direction, respectively. In addition, three or more heaters and/or three or more induction coils may be included.

According to one embodiment, the susceptor may be disposed on (or included in) the inner side (e.g., the medium portion) of the aerosol-generating article 2. The susceptor included inside the aerosol-generating article 2 may be implemented to be heated based on a magnetic field generated by the induction coil 181.

Referring to FIG. 2b, the heater 183 may be an external heating-type heater.

According to one embodiment, the external heating-type heater may be elongated upwardly around the space into which the aerosol-generating article 2 is inserted (i.e., the insertion space). For example, the external heating-type heater may be disposed so as to surround at least a portion of the insertion space. In an example, the external heating-type heater may include a tube shape (e.g., a cylindrical shape) with a cavity formed therein. The external heating-type heater may alternatively include a shape including a cavity formed therein and surrounding the cavity. In this case, the external heating-type heater may be supported by a polyimide film. The heater supported by this film may be referred to as a film heater. The external heating-type heater may be disposed so as to surround at least a portion of the insertion space. The external heating-type heater may heat the outer side of the aerosol-generating article 2 inserted into the cavity.

According to one embodiment, the external heating-type heater may include an electro-resistive heater and/or an induction heater, and a description of configurations identical to those shown in FIG. 2a will be omitted. Meanwhile, in the case of an induction heater, the aerosol-generating device 1 may include an external heating-type heater implemented as a tubular susceptor and may include an induction coil 181 surrounding at least a portion of the external heating-type heater (e.g., disposed outside the heater so as to correspond to the length of at least a portion of the heater). In addition, the induction coil 181 may include a fan coil. Meanwhile, if the external heating-type heater is an electro-resistive heater, heat may be generated through current flow through the tubular electro-resistive heater (e.g., the film heater), and thus a separate induction coil 181 may be omitted. Meanwhile, a thermally insulating material may be disposed outside the external heating-type heater. Accordingly, the amount of heat emitted from the heater 183 in the radially outward direction and released outside the housing 10 may be reduced.

According to one embodiment, the heater 183 may be a multi-heater, and the first heater and the second heater may be disposed side by side in the longitudinal direction so as to surround at least a portion of the insertion space. The first heater and the second heater may operate as an electro-resistive heater and/or an induction heater, and may be heated sequentially or simultaneously. Meanwhile, if the heater 183 is an induction heater, the aerosol-generating device 1 may include a first induction coil and a second induction coil. The first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 183 in the longitudinal direction, respectively.

Unlike the configuration shown in FIG. 2a or FIG. 2b, both the heater 182 in FIG. 2a and the heater 183 in FIG. 2b may be included in the aerosol-generating device 1. In this case, the heater 182 may heat the inner side of the aerosol-generating article 2, and the heater 183 may heat the outer side of the aerosol-generating article 2.

According to one embodiment, the aerosol-generating device 1 may be provided with an airflow channel through which air flows. For example, the housing 10 may include a structure (e.g., a hole) through which outside air may be introduced into the housing 10. The air introduced into the housing 10 may be introduced into the aerosol-generating article 2 through the lower end (i.e., upstream side) of the aerosol-generating article 2. An aerosol generated based on heating of the aerosol-generating article 2 may be inhaled into the user's oral cavity together with the introduced air through the upper end (i.e., downstream side) of the aerosol-generating article 2.

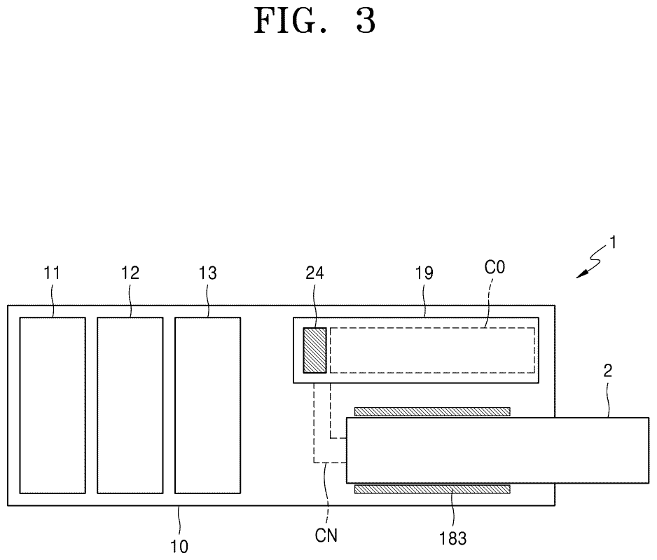

FIG. 3 shows an aerosol-generating device 1 according to an embodiment.

According to one embodiment, the aerosol-generating device 1 may include a housing 10, a power supply 11, a controller 12, a sensor unit 13, and/or a heater 183 and 24 (e.g., the heater 18 and 24 in FIG. 1). However, it will be understood by those skilled in the art related to the present embodiment that the components included in the aerosol-generating device 1 are not limited to those shown in FIG. 3 and that some of the components may be omitted or new components may be further included. In the drawings below, a description of configurations identical to those shown in FIG. 1 will be omitted.

According to one embodiment, the housing 10 may provide a space that is open upwardly to allow the aerosol-generating article 2 to be inserted thereinto (hereinafter referred to as an insertion space). The insertion space may be formed so as to be depressed in the housing 10 to a predetermined depth so that at least a portion of the aerosol-generating article 2 may be inserted thereinto. The lower end of the aerosol-generating article 2 may be inserted into the housing 10, and the upper end of the aerosol-generating article 2 may protrude outside the housing 10.

Unlike the configuration shown in the drawings, the cartridge 19 may provide an insertion space for receiving the aerosol-generating article 2. In this case, the insertion space may be formed so as to be depressed in the cartridge 19 to a predetermined depth so that at least a portion of the aerosol-generating article 2 may be inserted thereinto. The lower end of the aerosol-generating article 2 may be inserted into the cartridge 19, and the upper end of the aerosol-generating article 2 may protrude outside the cartridge 19. In this case, the aerosol-generating device 1 may not include the heater 183.

According to one embodiment, the depth of the insertion space may be equal to or greater than the length of a region of the aerosol-generating article 2 in which an aerosol-generating substance and/or a medium is contained. A user may inhale air while holding the externally exposed upper end of the aerosol-generating article 2 in the mouth.

According to one embodiment, the heater 183 may heat the aerosol-generating article 2. The heater 183 may be elongated upwardly around the space into which the aerosol-generating article 2 is inserted (i.e., the insertion space). In an example, the heater 183 may have a tube shape (e.g., a cylindrical shape) with a cavity formed therein. The heater 183 may include a shape including a cavity formed therein and surrounding the cavity. In this case, the heater 183 may be supported by a polyimide film. The heater supported by this film may be referred to as a film heater. The heater 183 may be disposed so as to surround at least a portion of the insertion space. The heater 183 may heat the outer side of the aerosol-generating article 2 inserted into the cavity. In the present disclosure, the heater 183 may be referred to as an external heating-type heater, which heats the outer side of the aerosol-generating article 2. Meanwhile, a thermally insulating material may be disposed outside the heater 183. Accordingly, the amount of heat emitted from the heater 183 in the radially outward direction and released outside the housing 10 may be reduced.

According to one embodiment, the heater 183 may include an electro-resistive heater and/or an induction heater.

For example, the electro-resistive heater may include an electro-resistive material, and may generate heat as current flows through the electro-resistive material. In this case, the electro-resistive heater may be electrically connected to the power supply 11, and may directly generate heat using current received from the power supply 11.

For example, in the case of an induction heater, the aerosol-generating device 1 may further include an induction coil (not shown) surrounding at least a portion of the heater 183 (e.g., disposed outside the heater 183 so as to correspond to the length of at least a portion of the heater 183). In this case, a magnetic flux concentrator may be further provided outside the induction coil (not shown) in order to increase efficiency of induction heating. The induction heater may include a susceptor, and may generate heat based on a magnetic field generated by the induction coil (not shown).

According to one embodiment, the heater 183 may be a multi-heater. The multi-heater may include a first heater and a second heater, and may be inserted into the aerosol-generating article 2. The first heater and the second heater may be disposed side by side in the longitudinal direction. The first heater and the second heater may operate as an electro-resistive heater and/or an induction heater, and may be heated sequentially or simultaneously. In this case, the first heater and the second heater may be disposed at positions corresponding to the positions of two or more aerosol-generating rods in the longitudinal direction, respectively. Alternatively, the first heater and the second heater may be disposed at positions corresponding to the positions of a first portion and a second portion of one aerosol-generating rod in the longitudinal direction, respectively. Meanwhile, if the heater 183 is an induction heater, the aerosol-generating device 1 may include a first induction coil and a second induction coil, and the first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 183 in the longitudinal direction, respectively. In addition, three or more heaters and/or three or more induction coils may be included.

Unlike the configuration shown in the drawings, the aerosol-generating device 1 may not include the heater 183. The aerosol-generating article 2 may be directly or indirectly heated by the cartridge heater 24 or may not be substantially heated. Indirect heating may mean that the aerosol-generating article 2 is heated by receiving heat contained in the aerosol during the process in which the aerosol generated by the cartridge heater 24 passes through the aerosol-generating article 2. In this case, the aerosol-generating device 1 may be referred to as a non-heating-type (or indirect heating-type) aerosol-generating device. An additive such as an alkaline substance may be contained in the aerosol-generating rod of the aerosol-generating article 2. Based on the alkaline substance, nicotine contained in the aerosol-generating rod may have an alkaline pH (e.g., pH 7.0 or higher). This alkaline nicotine may flow to the user's oral cavity together with the aerosol introduced into the aerosol-generating article 2 from the cartridge 19 to be described later.

Unlike the configuration shown in the drawings, the heater 183 may include an internal heating-type heater. For example, the internal heating-type heater may include various heating elements, such as a rod-shaped heating element, a tubular heating element, a plate-shaped heating element, or a needle-shaped heating element. The internal heating-type heater may be inserted through the lower portion of the aerosol-generating article 2, and may be set to heat the inner side of the aerosol-generating article 2.

According to one embodiment, the cartridge 19 may be removably coupled to the housing 10. For example, a space may be formed in one side of the housing 10, and at least a portion of the cartridge 19 may be inserted into the space formed in one side of the housing 10 so that the cartridge 19 is mounted to the housing 10. Alternatively, the cartridge 19 may be integrally formed with the housing 10.

According to one embodiment, the aerosol-generating device 1 and/or the cartridge 19 may be provided with an airflow channel through which air flows. For example, the housing 10 may include a structure allowing outside air to be introduced into the housing 10 in the state in which the cartridge 19 is inserted thereinto. The introduced air may pass through the cartridge 19, may be introduced into the insertion space through the airflow channel CN, and then may flow to the user's oral cavity. The airflow channel CN may include various structures for reducing residual droplets or making the flow of air smooth.

Although it is illustrated in FIG. 3 that the cartridge 19 is located beside the aerosol-generating article 2 and the airflow channel CN is formed from the side surface of the aerosol-generating article 2 to the lower end (i.e., upstream side) of the aerosol-generating article 2, the positions of the cartridge 19 and the airflow channel CN are not limited thereto. For example, the cartridge 19 may be located adjacent to the lower end (i.e., upstream side) of the aerosol-generating article 2. In this case, the airflow channel CN may be formed in a substantially straight shape to connect the cartridge 19 to the lower end (i.e., upstream side) of the aerosol-generating article 2.

According to one embodiment, the cartridge 19 may include a storage part C0 that contains an aerosol-generating substance, a cartridge heater 24, and/or a liquid delivery part that is impregnated with (contains) the aerosol-generating substance. The liquid delivery part may be impregnated with the aerosol-generating substance supplied from the chamber C0. For example, the liquid delivery part may include a wick formed of, e.g., cotton fiber, ceramic fiber, glass fiber, or porous ceramic.

According to one embodiment, the cartridge heater 24 may heat the aerosol-generating substance contained in the cartridge 19. For example, the cartridge heater 24 may include an electro-resistive heater and/or an induction heater.

In an example, the electro-resistive heater may include an electro-resistive material, and may generate heat as current flows through the electro-resistive material. In another example, in the case of an induction heater, the aerosol-generating device 1 may further include an induction coil (not shown) provided around the induction heater. The induction heater may include a susceptor, and may generate heat based on a magnetic field generated by the induction coil (not shown). The cartridge heater 24 may be formed in a coil shape surrounding (or wound around) the liquid delivery part and/or in a shape (e.g., a patterned shape) contacting one side of the liquid delivery part.

Unlike the configuration shown in the drawings, the cartridge heater 24 may be included in the aerosol-generating device 1. For example, the cartridge heater 24 may be included inside the housing 10. In this case, the cartridge 19 and the cartridge heater 24 may be separated by removal of the cartridge 19.

According to one embodiment, an aerosol may be generated based on generation of heat by the cartridge heater 24. For example, as the aerosol-generating substance impregnated in the liquid delivery part is heated by the cartridge heater 24, vapor may be generated from the aerosol-generating substance, and an aerosol may be generated as the generated vapor is mixed with the outside air introduced into the cartridge 19. The aerosol generated by the cartridge heater 24 may be introduced into the aerosol-generating article 2 through the airflow channel CN. While the aerosol passes through the aerosol-generating article 2, tobacco or a flavoring substance may be added to the aerosol, and the aerosol containing the tobacco or the flavoring substance may be inhaled into the user's oral cavity through one end of the aerosol-generating article 2.

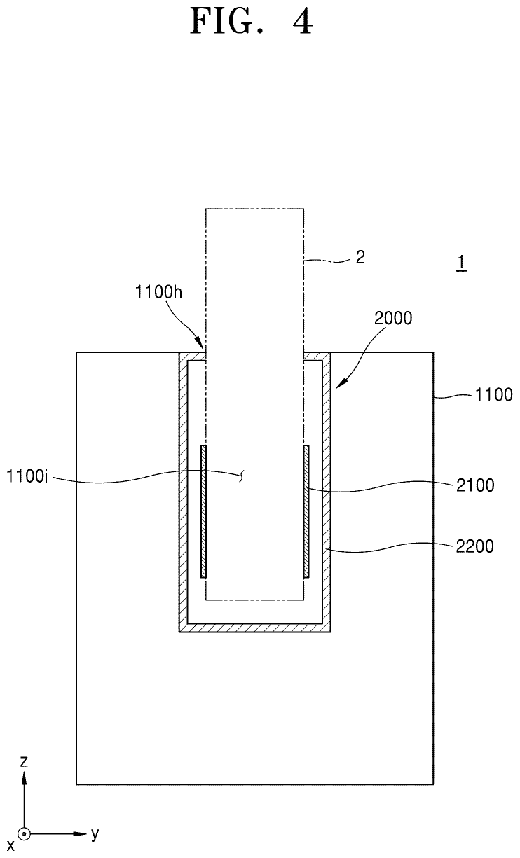

FIG. 4 is a cross-sectional view schematically illustrating the inside of the aerosol generating device according to an embodiment.

Referring to FIG. 4, the aerosol generating device 1 according to an embodiment may include a housing 1100 and a heater assembly 2000.

The housing 1100 corresponds to the same component as the housing 10 described with reference to FIG. 2A, and may form an overall exterior of the aerosol generating device 1. The housing 1100 may include an internal space in which components of the aerosol generating device 1 may be disposed.

For example, in the internal space of the housing 1100, the heater assembly 2000 for heating an aerosol generating article 2, a power supply (e.g., 11 in FIG. 1) for supplying power to the heater assembly 2000, and a control unit (e.g., 12 in FIG. 1) for controlling the power supplied to the heater assembly 2000 may be disposed.

The housing 1100 may include an opening 1100h into which the aerosol generating article 2 may be inserted into the housing 1100. At least a part of the aerosol generating article 2 may be inserted into or accommodated in the housing 1100 through the opening 1100h.

The housing 1100 may include an insertion space 1100i configured to accommodate the aerosol generating article 2 therein. The insertion space 1100i may be formed in an upper portion of the housing 1100. The insertion space 1100i may be opened upward to be connected to the opening 1100h.

The insertion space 1100i may have a cylindrical shape extending vertically. At least a part of the aerosol generating article 2 may be accommodated in the housing 1100 through the opening 1100h in an upper side of the insertion space 1100i. In this regard, a depth of the insertion space 1100i may correspond to a length of a region including an aerosol generating material or a medium in the aerosol generating article 2.

The heater assembly 2000 is a component for heating the aerosol generating article 2 accommodated in the housing 1100. That is, the heater assembly 2000 may be disposed in the internal space of the housing 1100, and heat the aerosol generating article 2 inserted into or accommodated in the housing 1100 through the opening 1100h.

The heater assembly 2000 may include the insertion space 1100i for accommodating the aerosol generating article 2. In this regard, the insertion space 1100i may correspond to the same component as the insertion space 1100i in the housing 1100 described above. When the aerosol generating article 2 inserted or into accommodated in the housing 1100 is accommodated in the insertion space 1100i of the heater assembly 2000, the heater assembly 2000 may be disposed to surround at least one region of the aerosol generating article 2 to heat the aerosol generating article 2.

According to an embodiment, the heater assembly 2000 may include an inner assembly 2100 disposed therein and an outer assembly 2200 disposed outside the inner assembly 2100. The inner assembly 2100 may include a heater for heating the aerosol generating article 2 and an insulation structure disposed around the heater. The outer assembly 2200 may include covers supporting the inner assembly 2100 and protecting the inner assembly 2100 from an external environment.

As shown, the insertion space 1100i is formed inside the inner assembly 2100. The aerosol generating article 2 may be inserted into the heater assembly 2000 through an open region of the outer assembly 2200 aligned with the opening 1100h and accommodated in the insertion space 1100i. The aerosol generating article 2 may be heated by the heater which is one component of the inner assembly 2100, thereby generating an aerosol.

Hereinafter, a specific structure of the heater assembly 2000 will be described in detail.

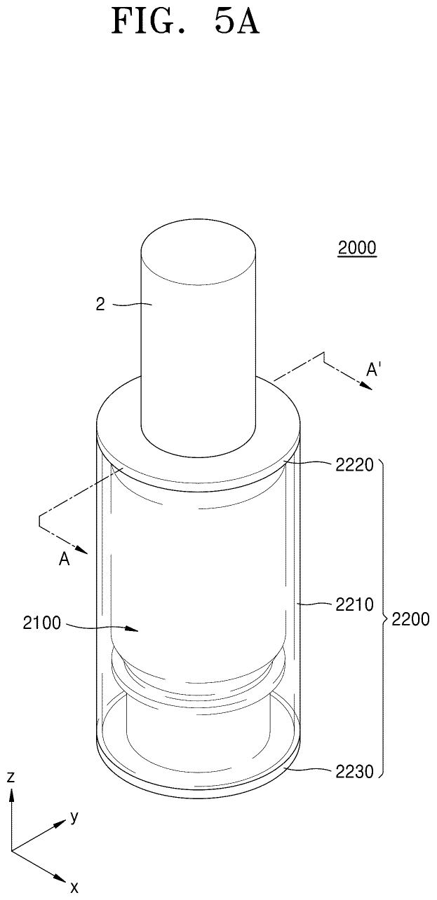

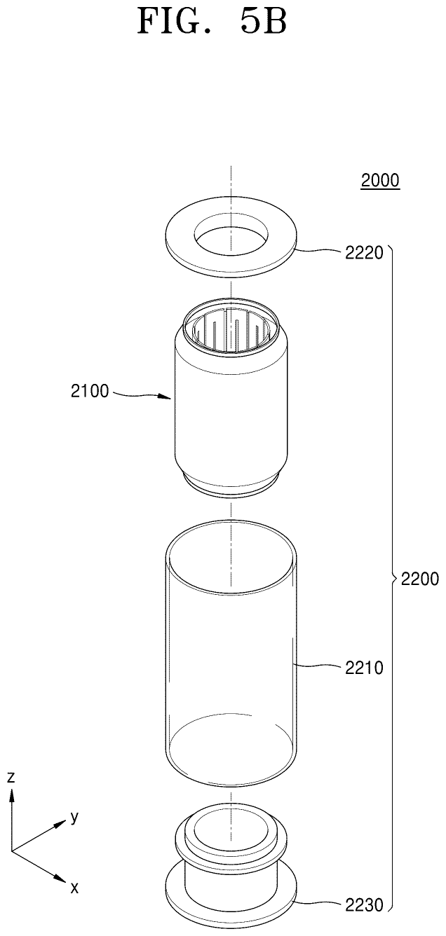

FIG. 5A is a perspective view of the heater assembly 2000 according to an embodiment. FIG. 5B is an exploded perspective view of the heater assembly 2000 illustrated in FIG. 5A. For convenience of explanation, only some components, not all components of the heater assembly, are illustrated in FIG. 5B.

Referring to FIGS. 5A and 5B, the heater assembly 2000 according to an embodiment may include the inner assembly 2100 and the outer assembly 2200. Detailed descriptions of the configuration and effects of the heater assembly 2000 which are redundant with those described above will be omitted.

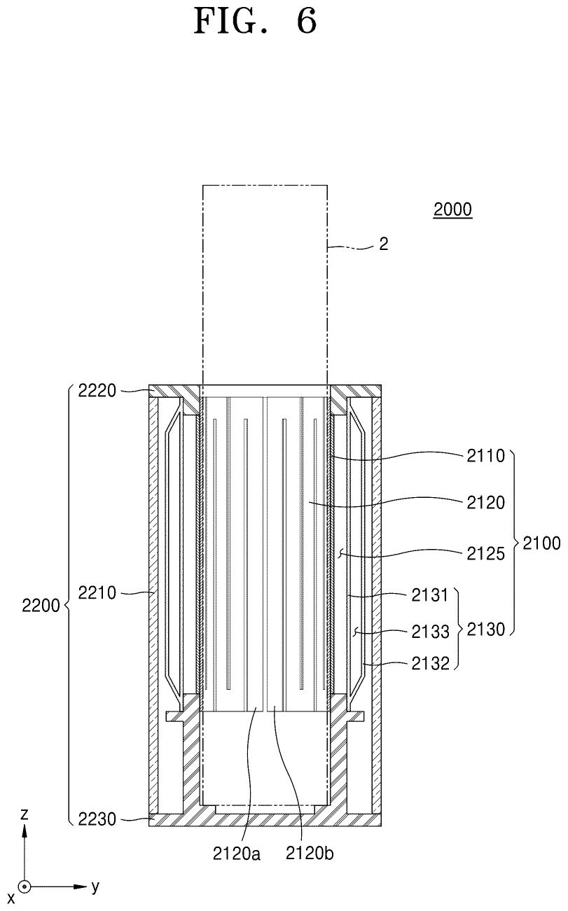

As described above, the inner assembly 2100 may include a heater for heating the aerosol generating article 2 and an insulation structure disposed around the heater. The inner assembly 2100 may be surrounded by the outer assembly 2200 and supported by a part of the outer assembly 2200. The configuration of the inner assembly 2100 will be described below with reference to FIG. 6.

The outer assembly 2200 may include a side cover 2210 surrounding an outer surface of the inner assembly 2100, an upper cover 2220 and a lower cover 2230 wrapping upper and lower portions of the inner assembly 2100.

As shown, the heater assembly 2000 may be assembled in such a way that the inner assembly 2100 is inserted into the side cover 2210, and then the upper cover 2220 and the lower cover 2230 are coupled to an upper side and a lower side of the side cover 2210, respectively. Accordingly, the inner assembly 2100 may be disposed in a space surrounded by the side cover 2210, the upper cover 2220, and the lower cover 2230.

The side cover 2210 may include a hollow cylindrical shape (e.g., a tube shape). In this regard, the side cover 2210 may be spaced apart from the inner assembly 2100 by a certain distance. Specifically, an inner surface of the side cover 2210 may be spaced apart from an outer surface of the inner assembly 2100 without contacting the outer surface of the inner assembly 2100.

A central axis of the side cover 2210 in a longitudinal direction may be the same as a central axis of the inner assembly 2100 in the longitudinal direction. Therefore, a distance between the inner surface of the side cover 2210 and the outer surface of the inner assembly 2100 may be the same at all points.

An empty space between the side cover 2210 and the inner assembly 2100 may be filled with air or may be in a vacuum state. When the empty space between the two components is filled with air, the air may be maintained in a stopped state without moving, such as flowing into the empty space from the outside or flowing to the outside from the empty space. Such a structure may prevent a phenomenon in which heat emitted from the inner assembly 2100 is transferred to the outside of the outer assembly 2200 through the side cover 2210. In addition, the side cover 2210 may include an insulating material that does not transfer heat well.

In general, a user may use the aerosol generating device 1 while holding a side portion of a housing (e.g., the housing 1100 of FIG. 4). In this regard, the side cover 2210 may be disposed in parallel with the side portion of the housing 1100. As described above, the presence of the side cover 2210 may prevent the heat generated inside the heater assembly 2000 from being transferred to the side portion of the housing 1100, thereby protecting a user's hand gripping the housing 1100 from heat.

The upper cover 2220 and the lower cover 2230 may be coupled to an upper side and a lower side of the side cover 2210, respectively. For example, a part of the upper cover 2220 and a part of the lower cover 2230 may be inserted into the side cover 2210 through both open ends of the side cover 2210.

Accordingly, the upper cover 2220 may be disposed in an upper portion of the inner assembly 2100, and the lower cover 2230 may be disposed in a lower portion of the inner assembly 2100. In this regard, each of the upper cover 2220 and the lower cover 2230 may be engaged with the inner assembly 2100 through a part to support the inner assembly 2100.

As shown, the upper cover 2220 may be opened to allow the aerosol generating article 2 to penetrate therethrough. One open region of the upper cover 2220 may be aligned with the opening 1100h of the housing 1100 in the longitudinal direction (e.g., z-axis direction) of the heater assembly 2000 or the aerosol generating device 1.

The aerosol generating article 2 may penetrate one open region of the upper cover 2220 to be inserted into the inner assembly 2100. In this regard, one open region of the upper cover 2220 may be connected to an internal space (e.g., the insertion space 1100i of FIG. 4) of the inner assembly 2100. Therefore, the aerosol generating article 2 may penetrate one open region of the upper cover 2220 to be inserted into the insertion space 1100i formed in the inner assembly 2100.

The upper cover 2220 may support an outer circumferential surface of the aerosol generating article 2 passing through one open region of the upper cover 2220. Accordingly, the aerosol generating article 2 may not move inside the heater assembly 2000, and the user may stably inhale an aerosol through the aerosol generating article 2.

According to an embodiment, each of the upper cover 2220 and the lower cover 2230 may include a material that transfers heat relatively well compared to the side cover 2210. Accordingly, heat emitted from the inner assembly 2100 may be discharged to the outside of the heater assembly 2000 through the upper cover 2220 and the lower cover 2230. That is, heat generated inside the heater assembly 2000 may be mainly dissipated through the upper and lower portions of the heater assembly 2000 rather than side portions.

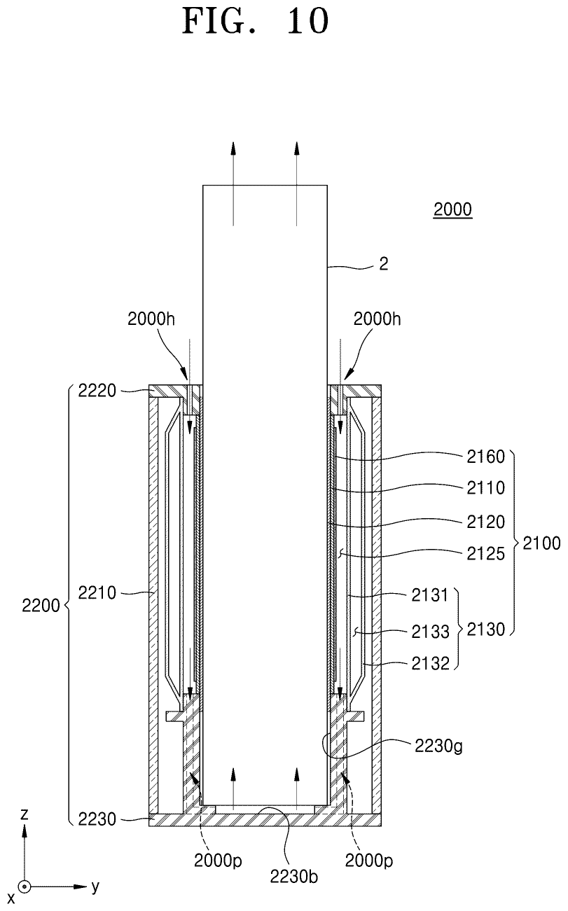

Meanwhile, although not shown, each of the upper cover 2220 and the lower cover 2230 may include a passage through which air may move. An airflow path disposed in each of the upper cover 2220 and the lower cover 2230 may be fluidly connected to a specific space formed inside the inner assembly 2100. In this regard, ‘fluid connection’ may mean that elements are connected to each other such that a fluid such as air may pass through and flow. The movement of air inside the heater assembly 2000 will be described below with reference to FIG. 10.

FIG. 6 is a cross-sectional view of the heater assembly 2000 illustrated in FIG. 5A taken along a cross-sectional line A-A′.

Referring to FIG. 6, the heater assembly 2000 according to an embodiment may include the inner assembly 2100 and the outer assembly 2200. Detailed descriptions of the configuration and effects of the heater assembly 2000 which are redundant with those described above will be omitted.

The inner assembly 2100 may include a supporter 2110, a heater 2120, and an insulator 2130. As shown, the heater 2120 may be disposed inside the supporter 2110, and the insulator 2130 may be disposed outside the supporter 2110.

The supporter 2110 is a component for surrounding the aerosol generating article 2 and supporting an outer circumferential surface of the aerosol generating article 2. The supporter 2110 may include a hollow cylindrical shape (e.g., a tube shape). In this regard, a space surrounded by the supporter 2110 may correspond to an insertion space (e.g., the insertion space 1100i of FIG. 4). That is, the supporter 2110 may include the insertion space 1100i for accommodating the aerosol generating article 2.

According to an embodiment, both ends of the supporter 2110 may be opened according to the tube shape of the supporter 2110. The upper cover 2220 of the outer assembly 2200 may be disposed in an upper side of the supporter 2110, and the lower cover 2230 of the outer assembly 2200 may be disposed in a lower side of the supporter 2110. Therefore, both open ends of the supporter 2110 may face the upper cover 2220 and the lower cover 2230, respectively.

The upper cover 2220 and the lower cover 2230 may respectively include empty spaces connected to both open ends of the supporter 2110. The insertion space 1100i surrounded by the supporter 2110 may be connected to the empty spaces formed in the upper cover 2220 and the lower cover 2230.

In this regard, the empty space of the upper cover 2220 connected to the insertion space 1100i may mean one open region of the upper cover 2220 described with reference to FIGS. 5A and 5B. The empty space of the lower cover 2230 connected to the insertion space 1100i may mean a groove of the lower cover 2230 to be described below.

The aerosol generating article 2 inserted into the heater assembly 2000 may penetrate the insertion space 1100i and occupy at least a part of the empty spaces formed in the upper cover 2220 and the lower cover 2230.

The heater 2120 may heat the aerosol generating article 2 accommodated in the insertion space 1100i to generate an aerosol from the aerosol generating article 2. The heater 2120 may correspond to the same component as the heater 18 described with reference to FIG. 2A. The heater 2120 may extend vertically along the insertion space 1100i.

At least one region of the aerosol generating article 2 accommodated in the insertion space 1100i may be heated by the heater 2120, and vaporized particles generated by heating the aerosol generating article 2 and air moving along an airflow passage and flowing into the insertion space 1100i may be mixed to generate the aerosol.

According to an embodiment, the heater 2120 may be disposed in an inner surface of the supporter 2110 to surround at least a part of the aerosol generating article 2. In this case, the heater 2120 may have a thin film shape. Therefore, the aerosol generating article 2 accommodated in the insertion space 1100i may be in contact with the inner surface of the supporter 2110 and the heater 2120 simultaneously.

The heater 2120, which is an ‘external heating type heater’ disposed outside the aerosol generating article 2, may be in contact with the outer circumferential surface of the aerosol generating article 2 to directly heat the aerosol generating article 2.

Compared to an ‘indirect heating method’ that the heater is disposed on an outer surface of the supporter 2110 to heat the aerosol generating article 2 in contact with the supporter 2110 by heating the supporter 2110, the heater 2120 of the heater assembly 2000 according to an embodiment directly heats the aerosol generating article 2, and thus, the heating efficiency of the aerosol generating article 2 may be improved.

According to an embodiment, the heater 2120 may have a specific pattern. In this regard, the heater 2120 is an electric resistive heater including an electric resistor, and heat may be generated along a pattern when power is supplied to the heater 2120. A partial region of the aerosol generating article 2 in contact with the pattern may be directly heated by the heater 2120.

As shown, the heater 2120 may include a bent or curved pattern continuously disposed in one direction (e.g., a direction surrounding the insertion space 1100i). In this regard, both ends of the pattern forming the heater 2120 may not be connected to each other. That is, the heater 2120 may include a pattern by which one end 2120a and the other end 2120b are distinguished from each other, other than a closed loop-shaped pattern. However, the pattern for determining the appearance of the heater 2120 is not limited to the illustrated shape.

Meanwhile, the heater 2120 may have a specific pattern and an overall hollow cylindrical shape (e.g., a tube shape) simultaneously. Accordingly, the heater 2120 may be disposed to surround at least a part of the insertion space 1100i. In this regard, the heater 2120 may extend past both open ends of the supporter 2110. An upper end and a lower end of the heater 2120 may be inserted into the upper cover 2220 and the lower cover 2230, respectively. For example, the upper end and the lower end of the heater 2120 may be inserted into the empty spaces formed in the upper cover 2220 and the lower cover 2230, respectively.

According to such a structure, the aerosol generating article 2 may be heated not only inside the supporter 2110 but also in a wider region. In other words, the aerosol generating article 2 may be heated in a wider range beyond the region surrounded by the supporter 2110. However, the shape of the heater 2120 is not limited to that illustrated.

The insulator 2130 is a component for blocking heat generated by the heater 2120 from being transferred to the outside of the heater assembly 2000. The insulator 2130 may be disposed outside the supporter 2110 to surround the supporter 2110.

The insulator 2130 may be spaced apart from the outer surface of the supporter 2110. A separation space 2125 between the supporter 2110 and the insulator 2130 may function as the insulation space 2125. For example, the separation space 2125 between the supporter 2110 and an inner wall 2131 of the insulator 2130, which is an air gap filled with air, may prevent heat from being transferred from the supporter 2110 to the insulator 2130. In this regard, the separation space 2125 is not only a space filled with air, but may also function as a movement passage of air.

The insulator 2130 may include a double wall structure to increase the efficiency of insulation. Specifically, the insulator 2130 may include the inner wall 2131 facing the supporter 2110, and an outer wall 2132 at least partially spaced apart from the inner wall 2131.

The inner wall 2131 may have a hollow cylindrical shape (e.g., a tube shape), and be spaced apart from the outer surface of the supporter 2110 by a certain distance to surround the supporter 2110. Similarly, the outer wall 2132 may have a hollow cylindrical shape (e.g., a tube shape), and be spaced apart from an outer surface of the inner wall 2131 by a certain distance to surround the inner wall 2131. In this regard, both ends of the outer wall 2132 may extend toward the outer surface of the inner wall 2131 to be coupled to the inner wall 2131. Accordingly, a closed empty space may exist between the inner wall 2131 and the outer wall 2132.

A space 2133 between the inner wall 2131 and the outer wall 2132 may function as the insulation space 2133. For example, the space 2133 between the inner wall 2131 and the outer wall 2132 may be disposed in a vacuum state. Here, the ‘vacuum state’ does not mean only a state where there is no air at all, but may also include a state where a pressure is lower than the surrounding atmospheric pressure.

In summary, the insulator 2130 may include the insulation space 2133 in the vacuum state formed between the inner wall 2131 and the outer wall 2132, and the insulation space 2133 in the vacuum state may minimize heat transfer to the outside of the heater assembly 2000.

According to an embodiment, at least one of the supporter 2110, the heater 2120, or the insulator 2130 constituting the inner assembly 2100 may be supported by the upper cover 2220 and the lower cover 2230 constituting the outer assembly 2200.

An upper portion and a lower portion of the supporter 2110 may be supported by the upper cover 2220 and the lower cover 2230, respectively. As shown, an upper part (e.g., an upper side surface) and a lower part (e.g., a lower side surface) of the supporter 2110 are in contact with the upper cover 2220 and the lower cover 2230, respectively, but the embodiment is not limited thereto.

An upper portion and a lower portion of the heater 2120 may also be supported by the upper cover 2220 and the lower cover 2230, respectively. As shown, an upper region and a lower region of an outer surface of the heater 2120 are in contact with the upper cover 2220 and the lower cover 2230, respectively, but the embodiment is not limited thereto.

Similarly, an upper portion and a lower portion of the insulator 2130 may be supported by the upper cover 2220 and the lower cover 2230, respectively. As shown, the inner wall 2131 of the insulator 2130 may be in contact with the upper cover 2220 and the lower cover 2230 respectively through the upper part and the lower part thereof. In this regard, the upper part and the lower part of the inner wall 2131 may include not only the upper/lower ends of the inner wall 2131 but also upper/lower regions of the inner surface.

The upper cover 2220 and the lower cover 2230 may have appropriate shapes to support the upper part and the lower part of the inner wall 2131, respectively. For example, in the upper cover 2220 and the lower cover 2230, a step may be formed to engage with the inner wall 2131, or an extension or protrusion may extend in a direction away from the insertion space 1100i.

Meanwhile, the lower cover 2230 may include a groove for accommodating one end of the aerosol generating article 2. The aerosol generating article 2 inserted into the heater assembly 2000 may pass through the insertion space 1100i formed in the inner assembly 2100 and be seated in the groove formed in the lower cover 2230.

The lower cover 2230 may support one end of the aerosol generating article 2 accommodated in the groove. In this regard, the lower cover 2230 may support not only the lower surface of the aerosol generating article 2 but also the outer peripheral surface adjacent thereto. The aerosol generating article 2 is doubly supported by the upper cover 2220 and the lower cover 2230, and thus, the aerosol generating article 2 may not move inside the heater assembly 2000.

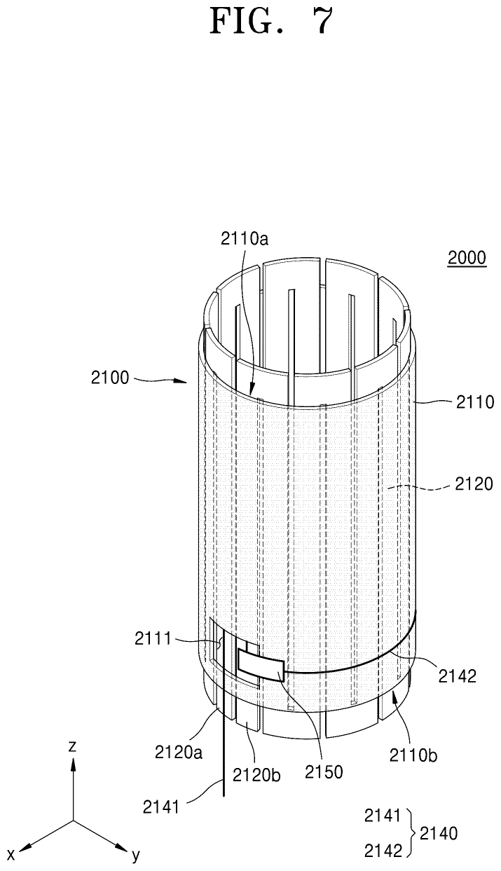

FIG. 7 is a perspective view illustrating an example of an internal structure of the heater assembly 2000 according to an embodiment.

Referring to FIG. 7, some components of the inner assembly 2100 constituting the heater assembly 2000 according to an embodiment are illustrated. As shown, the inner assembly 2100 may include the supporter 2110, the heater 2120, and a pair of connectors 2140. Detailed descriptions of the configuration and effects of the heater assembly 2000 which are redundant with those described above will be omitted.

The pair of connectors 2140 are electrically connected to the heater 2120 to supply power to the heater 2120. For example, the pair of connectors 2140 may be two conducting wires.

The heater 2120 may be connected to a power supply (e.g., the power supply 11 of FIG. 1) of an aerosol generating device (e.g., the aerosol generating device 1 of FIG. 4) through the pair of connectors 2140. For example, the one end 2120a of the heater 2120 may be connected to one 2141 of the pair of connectors 2140, and the other end 2120b of the heater 2120 may be connected to the other one 2142 of the pair of connectors 2140.

For convenience of description, hereinafter, the one 2141 of the pair of connectors 2140 may be referred to as the first connector 2141, and the other one 2142 of the pair of connectors 2140 may be referred to as the second connector 2142.

The pair of connectors 2140, the heater 2120, and the power supply may electrically form a closed loop. Current may flow from the power supply to the heater 2120 through the first connector 2141, and flow back to the power supply through the second connector 2142 after flowing along the pattern of the heater 2120. Accordingly, the heater 2120, which is an electric resistor, may heat the aerosol generating article 2 accommodated in an insertion space (e.g., the insertion space 1100i of FIG. 4) while generating heat according to the flow of the current.

According to an embodiment, as the heater 2120 has a specific pattern, the one end 2120a and the other end 2120b of the heater 2120 may be disposed adjacent to each other and extend in parallel. For example, the one end 2120a and the other end 2120b of the heater 2120 may extend to a lower side of the heater 2120.

In general, when the heater 2120 has the above structure, the pair of connectors 2140 respectively connected to the one end 2120a and the other end 2120b of the heater 2120 may be disposed adjacent to each other and extend in parallel.

In this regard, because the heater assembly 2000 is disposed adjacent to an opening (e.g., the opening 1100h of FIG. 4) inside a housing (e.g., the opening 1100h of FIG. 4), the heater assembly 2000 may be disposed in an upper portion of the housing 1100, and the power supply for supplying power to the heater assembly 2000 may be disposed in a lower side of the heater assembly 2000. Accordingly, the pair of connectors 2140 may also extend to the heater 2120 or the lower side of the heater assembly 2000.

According to such a structure, during the use of the heater assembly 2000 or the aerosol generating device 1, a short circuit may occur between the first connector 2141 and the second connector 2142 due to a reason such as the pair of connectors 2140 tangled or twisted together. This may cause a decrease in the heat generation performance of the heater 2120.

In this regard, because both ends 2120a and 2120b of the heater 2120 are located adjacent to each other, the pair of connectors 2140 respectively connected to both ends 2120a and 2120b of the heater 2120 may be disposed adjacent to each other at least in a part connected to the heater 2120. However, when the pair of connectors 2140 connected to the heater 2120 are connected to both electrodes of the power supply, the arrangement of the pair of connectors 2140 in other parts may not significantly affect the power supply to the heater 2120. According to this, the pair of connectors 2140 may not remain an adjacent to each other from the part connected to the heater 2120, and not extend in parallel in the same direction.

According to an embodiment, the first connector 2141 and the second connector 2142 may extend in different directions so as to be away from each other. According to such an arrangement, a phenomenon in which the pair of connectors 2140 are entangled or twisted with each other may be prevented. Accordingly, the heating performance or heating efficiency of the heater 2120 may be maintained in the best state without being degraded.

However, when there is no separate component supporting the first connector 2141 or the second connector 2142, there may still be a possibility that the pair of connectors 2140 may be entangled or twisted with each other. For example, when the first connector 2141 and the second connector 2142 are connected to one region of the one end 2120a and one region of the other end 2120b of the heater 2120 protruding downward from the supporter 2110, respectively, because there is no component supporting the first connector 2141 and the second connector 2142 other than the heater 2120 and the power supply, the pair of connectors 2140 may be in a state of freely moving in the air. Accordingly, the above-described problem may still occur.

In order to solve the above-described technical problem, at least one region of the supporter 2110 of the heater assembly 2000 according to an embodiment may include a through hole 2111 that is opened to face the insertion space 1100i. In this regard, the through hole 2111 may mean a hole that penetrates the structure itself called the supporter 2110 in a radial direction of the supporter 2110, apart from both ends of the supporter 2110 that opens due to the tube shape.

Because the heater 2120 is disposed on an inner surface of the supporter 2110, one region of the heater 2120 may be exposed to the outside of the supporter 2110 through the through hole 2111. In this regard, the pair of connectors 2140 respectively connected to the one end 2120a and the other end 2120b of the heater 2120 may be exposed to the outside of the supporter 2110 through the through hole 2111.

According to an embodiment, the pair of connectors 2140 may extend to the outside of the supporter 2110 through the through hole 2111. The first connector 2141 and the second connector 2142 located outside the supporter 2110 may extend in different directions so as to be away from each other and be in contact with an outer surface of the supporter 2110. Accordingly, the first connector 2141 and the second connector 2142 may be supported by the supporter 2110.

As parts of the pair of connectors 2140 supported by other components increase, the part that may move freely in the air may decrease. Accordingly, the phenomenon in which the pair of connectors 2140 are entangled or twisted with each other may be prevented.

At least one of the pair of connectors 2140 may surround the outer side of the supporter 2110 through a part thereof. Specifically, at least one of the pair of connectors 2140 may include a portion extending in a circumferential direction of the supporter 2110 so as to surround the outside of the supporter 2110.

As shown, the first connector 2141 may pass through the through hole 2111 to be connected to the power supply located in the lower side of the heater assembly 2000 and extend in the longitudinal direction of the supporter 2110 to face one electrode of the power supply. Unlike this, the second connector 2142 may pass through the through hole 2111 and extend in the circumferential direction of the supporter 2110. For example, the second connector 2142 may extend to surround half of an outer circumference of the supporter 2110. Accordingly, the second connector 2142 extending in the circumferential direction of the supporter 2110 may extend in the longitudinal direction of the supporter 2110 from the opposite side of the first connector 2141 with the supporter 2110 disposed therebetween to face the other electrode of the power supply.

Even when the pair of connectors 2140 are disposed adjacent to each other in the portion connected to the heater 2120, because the first connector 2141 and the second connector 2142 extend toward the power supply located in the lower side of the heater assembly 2000 at a position away from each other, the phenomenon in which the pair of connectors 2140 are entangled or twisted with each other may be prevented.

Meanwhile, the through hole 2111 may be disposed in a lower region of the supporter 2110. In other words, the through hole 2111 may be disposed adjacent to the lower end 2110b of the supporter 2110. As the through hole 2111 is disposed as close as possible to the power supply located in the lower side of the heater assembly 2000, lengths of the pair of connectors 2140 required to connect the heater 2120 to the power supply may be shortened. Accordingly, the phenomenon in which the pair of connectors 2140 are entangled or twisted with each other may be prevented. However, the embodiment is not limited thereto, and the through hole 2111 may be disposed adjacent to the upper end 2110a of the supporter 2110.

Referring to FIG. 7, the inner assembly 2100 constituting the heater assembly 2000 according to an embodiment may further include a fixer 2150 for coupling at least one of the pair of connectors 2140 to the supporter 2110.

For example, when the pair of connectors 2140 have high rigidity and thus are not well deformed, the pair of connectors 2140 may maintain a specific shape and remain in contact with the outer surface of the supporter 2110 without the separate fixer 2150.

However, when the pair of connectors 2140 may be easily deformed, it may be difficult for the pair of connectors 2140 to remain in contact with the outer surface of the supporter 2110. In this regard, the fixer 2150 may couple at least one of the pair of connectors 2140 to the outer surface of the supporter 2110. As one of the pair of connectors 2140 is fixed to the supporter 2110 through the fixer 2150, the part of the pair of connectors 2140 that may freely move is reduced, and the phenomenon in which the pair of connectors 2140 are entangled or twisted with each other may be prevented.

As shown, the fixer 2150 may couple or attach a part of the second connector 2142 extending in the circumferential direction of the supporter 2110 to the outside of the supporter 2110. Although not shown, the fixer 2150 may also be applied to the first connector 2141 extending in the longitudinal direction of the supporter 2110.

In addition, the fixer 2150 may couple at least one of the pair of connectors 2140 to the supporter 2110 by using various methods, for example, screw coupling. According to the embodiment, the supporter 2110 may include a structure that may be coupled to the pair of connectors 2140. In this case, the pair of connectors 2140 may remain in contact with the outer surface of the supporter 2110 without the separate fixer 2150.

Meanwhile, according to the embodiment, at least one (e.g., the second connector 2142) of the pair of connectors 2140 connected to the heater 2120 may extend only to the part connected to the fixer 2150. In this regard, the fixer 2150 may include an electrically conductive material, and a separate connector may be connected to the fixer 2150 to extend toward the power supply. According to such a structure, the heater 2120 and the power supply may be electrically connected to each other through the second connector 2142, the fixer 2150, and a separate connector. However, even in this case, the second connector 2142 and the separate connector may be coupled to the supporter 2110 through the fixer 2150, and a part of each of the second connector 2142 and the separate connector may be fixed to the supporter 2110.

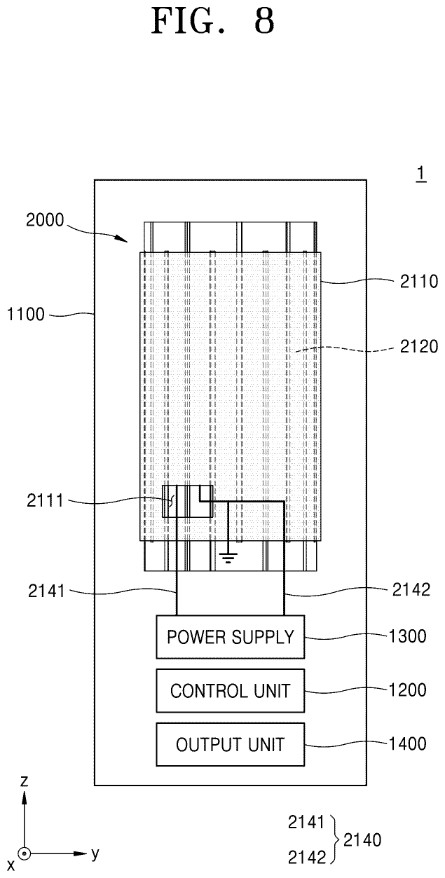

FIG. 8 is a diagram illustrating the heater assembly 2000 to which the internal structure illustrated in FIG. 7 is applied and the aerosol generating device 1 including the heater assembly 2000.

Referring to FIG. 8, the aerosol generating device 1 according to an embodiment may include the housing 1100, a control unit 1200, a power supply 1300, an output unit 1400, and the heater assembly 2000. Detailed descriptions of the configuration and effects of the aerosol generating device 1 which are redundant with those described above will be omitted.

The control unit 1200 corresponds to the same component as the control unit 12 described with reference to FIG. 1, and may control the overall operation of the aerosol generating device 1. For example, the control unit 1200 may monitor the temperature of the heater 2120 and control the temperature of the heater 2120 to a preset temperature.

The power supply 1300 corresponds to the same component as the power supply 11 described with reference to n FIG. 1, and may supply power for the operation of the aerosol generating device 1. For example, the power supply 1300 may supply power to the heater 2120 through the pair of connectors 2140.

The output unit 1400 corresponds to the same component as the output unit 14 described with reference to FIG. 1, and may output information about a state of the aerosol generating device 1. For example, the output unit 1400 may provide a user with information about a state of the heater 2120. The output unit 1400 may be electrically connected to the control unit 1200 and operate by a command of the control unit 1200.

The supporter 2110 may include a material having electrical conductivity. For example, the supporter 2110 may include stainless steel. In this regard, because the heater 2120 disposed on an inner surface of the supporter 2110 also includes an electrical resistor, when the supporter 2110 and the heater 2120 are in contact with each other, there may be a problem in that the supporter 2110 and the heater 2120 are electrically connected to each other.

According to an embodiment, the supporter 2110 may be insulated so that the supporter 2110 and the heater 2120 may be electrically insulated from each other. For example, an insulating material may be applied to the inner surface and an outer surface of the supporter 2110, or a glaze including the insulating material may be coated thereon.

In this regard, because the heater 2120 is disposed on the inner surface of the supporter 2110 which has already been insulated, no current may flow between the heater 2120 and the supporter 2110. Likewise, because the pair of connectors 2140 are also disposed on the outer surface of the supporter 2110 that has already been insulated, no current may flow between the pair of connectors 2140 and the supporter 2110.

However, as the heater assembly 2000 or the aerosol generating device 1 is used, there may be a problem of insulation breakdown. For example, the coating of the insulating material treated on the inner surface of the supporter 2110 may peel off. As a result, a problem in that current flows between the heater 2120 and the supporter 2110 may occur. This problem may lead to performance degradation of the heater 2120 in terms of heat generation, and accordingly, the aerosol generating article 2 may not be sufficiently heated.

In this regard, when a user is able to recognize the situation of insulation breakdown, the user may take measures such as replacing the heater assembly 2000 or repairing an internal component. That is, when the aerosol generating device 1 is capable of providing a notification to the user about the situation of insulation breakdown, the aerosol generating device 1 may prevent the user from continuing to use the aerosol generating device 1 while the performance of the heater 2120 degrades.

According to an embodiment, the control unit 1200 may determine whether the supporter 2110 and the heater 2120 have been electrically connected to each other based on a change in the electrical characteristics or electrical state of the heater 2120.

For example, current may flow along a closed loop including the power supply 1300, the pair of connectors 2140, and the heater 2120. In this regard, when the supporter 2110 and the heater 2120 are electrically connected to each other due to the insulation breakdown therebetween, the current flowing along the closed loop may also partially flow through the supporter 2110 having electrical conductivity.

This phenomenon may be considered that electrical resistance is connected in parallel to the heater 2120. Accordingly, a voltage applied to the heater 2120 may vary, and an amount of current flowing through the heater 2120 may vary. The control unit 1200 may detect a change in the voltage applied to the heater 2120 or the current flowing through the heater 2120, and determine whether the supporter 2110 and the heater 2120 have been electrically connected to each other based on the change.

When it is determined that the supporter 2110 and the heater 2120 have been electrically connected to each other, the control unit 1200 may control the output unit 1400 to provide the notification of insulation breakdown to the user through the output unit 1400. The user may recognize the state of the insulation breakdown between the supporter 2110 and the heater 2120 through the notification, and may take appropriate measures in response thereto.

Meanwhile, the control unit 1200 may control the temperature of the heater 2120 based on the change in the electrical characteristics of the heater 2120. For example, the heater 2120 may include a material having a temperature coefficient resistance (TCR). Accordingly, a resistance value of the heater 2120 may vary according to a change in the temperature of the heater 2120.

In this regard, the control unit 1200 may calculate the resistance value of the heater 2120 by measuring the voltage applied to the heater 2120 or the current flowing through the heater 2120, and indirectly determine the temperature of the heater 2120 through the calculated resistance value. That is, the control unit 1200 may track the temperature of the heater 2120 through the resistance value of the heater 2120.

Accordingly, the control unit 1200 may determine the temperature of the heater 2120 by monitoring the change in the electrical characteristics of the heater 2120, and also determine whether the supporter 2110 and the heater 2120 remain electrically insulated from each other.

According to the embodiment, a sensor unit (e.g., the sensor unit 13 of FIG. 1) may monitor the change in the electrical characteristics of the heater 2120. In this case, the control unit 1200 may determine the current situation based on a result detected through the sensor unit.

For example, the control unit 1200 may determine the temperature of the heater 2120. In addition, the control unit 1200 may determine whether the insulation between the supporter 2110 and the heater 2120 is broken. The control unit 1200 may control the temperature of the heater 2120 or provide a notification to the user through the output unit 1400 based on a determination result.

On the other hand, one of the pair of connectors 2140 exposed to the outside of the supporter 2110 through the through hole 2111 may be electrically connected to the ground outside the supporter 2110. As shown, the second connector 2142 extending along a circumferential direction of the supporter 2110 is electrically connected to the ground.

In general, when alternating current flows through the heater 2120, the heater 2120 may serve as an antenna unintentionally emitting or receiving electromagnetic waves. However, as the second connector 2142 connected to the heater 2120 is grounded, the flow of current is shorted, which may suppress emission of electromagnetic waves.

Accordingly, the heater 2120 may no longer serve as the antenna and not interfere with communication between other components. In other words, when the ground is used, the heater 2120 or the pair of connectors 2140 that originally and unintentionally functioned as the antenna may act as an electromagnetic shield, thereby reducing signal interference of other components.

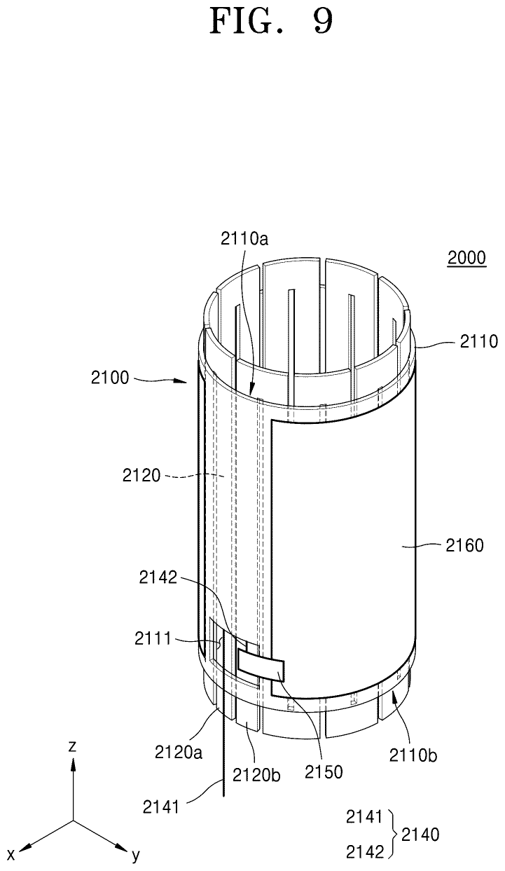

FIG. 9 is a perspective view illustrating another example of an internal structure of the heater assembly 2000 according to an embodiment.

Referring to FIG. 9, some components of the inner assembly 2100 constituting the heater assembly 2000 according to an embodiment are illustrated. As shown, the inner assembly 2100 may include the supporter 2110, the heater 2120, and the pair of connectors 2140. Detailed descriptions of the configuration and effects of the heater assembly 2000 which are redundant with those described above will be omitted.

According to an embodiment, a portion of at least one of the pair of connectors 2140 may surround an outer side of the supporter 2110. However, unlike illustrated in FIG. 7, the portion of the pair of connectors 2140 surrounding the outer side of the supporter 2110 may include a curved shape wrapping an outer surface of the supporter 2110. Hereinafter, the portion of the pair of connectors 2140 having the curved shape may be referred to as a curved portion 2160 of the pair of connectors 2140.

As shown, as the second connector 2142 includes the curved portion 2160, the second connector 2142 may wrap a large region of the supporter 2110. Specifically, compared to the second connector 2142 shown in FIG. 7 simply having a line structure, because the second connector 2142 shown in FIG. 9 has a surface structure, the second connector 2142 may wrap the large region of the supporter 2110. For example, in a longitudinal direction (e.g., z-axis direction) of the supporter 2110, a length of the curved portion 2160 of the second connector 2142 may be about 30 % to about 100 % of a length of the supporter 2110.

As the second connector 2142 has the surface structure, electrical resistance of the second connector 2142 may be significantly reduced. Accordingly, more current may flow through the heater 2120 connected to the second connector 2142, and thus the temperature of the heater 2120 may rapidly rise. That is, a preheating time of the heater 2120 may be shortened, and a time for a user to have to wait to use the aerosol generating device 1 may be shortened.

According to the embodiment, the curved portion 2160 wrapping the outer surface of the supporter 2110 may correspond to the separate conductor 2160. In this case, at least one of the pair of connectors 2140 may be electrically connected to the conductor 2160. In this regard, at least one of the pair of connectors 2140 and the conductor 2160 may be directly connected to each other or indirectly connected to each other through the fixer 2150 having electrical conductivity. When the fixer 2150 is disposed, the fixer 2150 may couple at least one of the pair of connectors 2140 and the conductor 2160 to the supporter 2110.

On the other hand, the curved portion 2160 or the conductor 2160 of the second connector 2142 may extend in an outer circumferential direction of the supporter 2110 to wrap most of the region of the supporter 2110 excluding a region in which the through hole 2111 is formed. Hereinafter, the advantages of such a structure will be described with reference to FIG. 10.

FIG. 10 is a cross-sectional view of the heater assembly 2000 to which the internal structure illustrated in FIG. 9 is applied. In this regard, FIG. 10 is the cross-sectional view of the heater assembly 2000 taken along the same cross-sectional line as the cross-sectional line A-A′ shown in FIG. 5A.

Referring to FIG. 10, the heater assembly 2000 according to an embodiment may include the inner assembly 2100 and the outer assembly 2200. The inner assembly 2100 may include the supporter 2110, the heater 2120, the insulator 2130, and the conductor 2160. The outer assembly 2200 may include the side cover 2210, the upper cover 2220, and the lower cover 2230. Detailed descriptions of the configuration and effects of the heater assembly 2000 which are redundant with those described above will be omitted.

According to an embodiment, air may flow into the heater assembly 2000. The flown air may move along an airflow passage formed inside the heater assembly 2000, and as a result, may be introduced into one end of the aerosol generating article 2 accommodated in an insertion space (e.g., the insertion space 1100i of FIG. 4).

Specifically, the upper cover 2220 coupled to an upper side of the insulator 2130 may include an inflow passage 2000h of air. Air outside the heater assembly 2000 may flow into the heater assembly 2000 through the inflow passage 2000h. The air having passed through the inflow passage 2000h may flow into the separation space 2125 between the supporter 2110 and the inner wall 2131 of the insulator 2130.

The lower cover 2230 coupled to a lower side of the insulator 2130 may include a transfer passage 2000p of air. The air having passed through the separation space 2125 may reach the transfer passage 2000p. The air passing through the transfer passage 2000p may flow into one end of the aerosol generating article 2.

In summary, the airflow passage may include the inflow passage 2000h formed in the upper cover 2220, the separation space 2125 between the supporter 2110 and the inner wall 2131 of the insulator 2130, and the transfer passage 2000p formed in the lower cover 2230.

The inflow passage 2000h, the separation space 2125, and the transfer passage 2000p may be fluidly connected to each other, and each may be fluidly connected to one end of the aerosol generating article 2 accommodated in the insertion space 1100i. Therefore, the air outside the heater assembly 2000 may sequentially pass through the inflow passage 2000h, the separation space 2125, and the transfer passage 2000p and flow into one end of the aerosol generating article 2 accommodated in the insertion space 1100i.

Meanwhile, the air having passed through the transfer passage 2000p may reach a bottom surface 2230 b of a groove 2230g formed in the lower cover 2230 before flowing into one end of the aerosol generating article 2.

In this regard, the lower cover 2230 may include a support disposed on the bottom surface 2230 b of the groove 2230g to support at least one of an outer circumferential surface or an end surface of the aerosol generating article 2. Because the end surface of the aerosol generating article 2 accommodated in the groove 2230g is supported by the support disposed on the bottom surface 2230b, the end surface of the aerosol generating article 2 and the bottom surface 2230 b of the groove 2230g may be spaced apart from each other by a length of the support.

Therefore, the air having passed through the transfer passage 2000p may flow into one end of the aerosol generating article 2 through a separated space between the end surface of the aerosol generating article 2 and the bottom surface 2230b of the groove 2230g.

The arrangement and shape of the inflow passage 2000h and the transfer passage 2000p are not limited to those illustrated. For example, the inflow passage 2000h may correspond to a space between a plurality of supports of the upper cover 2220 supporting the outer circumferential surface of the aerosol generating article 2. The transfer passage 2000p may correspond to a space between a plurality of supports of the lower cover 2230 supporting the outer circumferential surface or the end surface of the aerosol generating article 2.

On the other hand, as the conductor 2160 is disposed on the outer surface of the supporter 2110, air passing through the space 2125 between the supporter 2110 and the insulator 2130 may be in contact with the conductor 2160.

In this regard, because the conductor 2160 is an electrically conductive material and an electrically resistive material, when power is supplied to the heater 2120, current may flow through the conductor 2160 and heat may be generated from the conductor 2160. The air passing through the separation space 2125 may be heated by the heat generated from the conductor 2160.

The heated air may flow into one end of the aerosol generating article 2 to heat the inside of the aerosol generating article 2. Accordingly, the outer circumferential surface of the aerosol generating article 2 may be heated by the heater 2120, and the inside of the aerosol generating article 2 may be heated by air. As the medium of the aerosol generating article 2 is evenly heated, an amount of generated aerosols may increase, and accordingly, the aerosol generating device 1 may provide an abundant amount of atomization to the user.

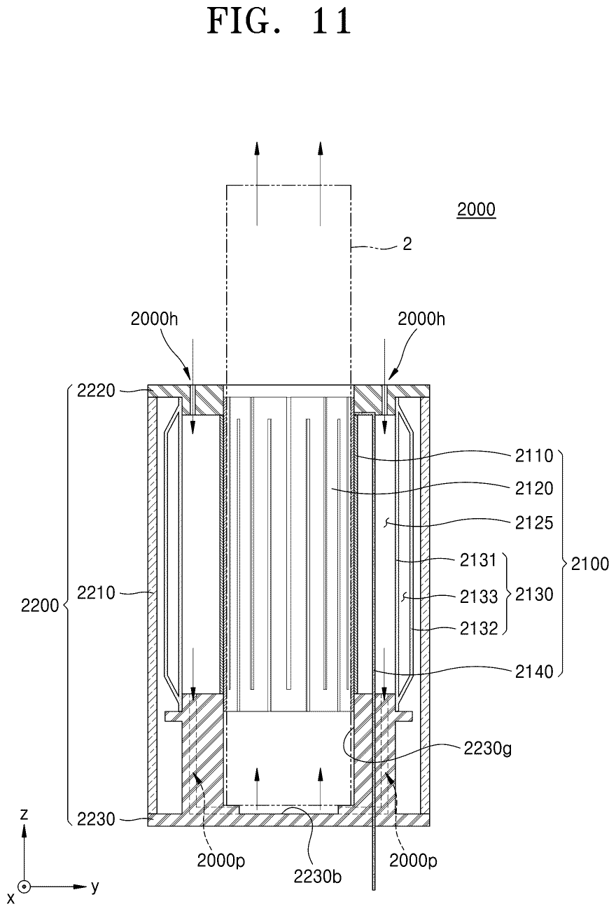

FIG. 11 is a cross-sectional view of an example of the heater assembly 2000 according to another embodiment. Specifically, FIG. 11 is the cross-sectional view of the example of the heater assembly 2000 according to another embodiment taken along the same cross-sectional line as the cross-sectional line of A-A′ illustrated in FIG. 5A.

Referring to FIG. 11, the heater assembly 2000 according to another embodiment may include the inner assembly 2100 and the outer assembly 2200. Detailed descriptions of the configuration and effects of the heater assembly 2000 which are redundant with those described above will be omitted.

According to another embodiment, the heater assembly 2000 may be disposed in an upper portion of the housing 1100, and a power supply may be located in a lower side of the heater assembly 2000. Accordingly, the pair of connectors 2140 may extend in a longitudinal direction of the housing 1100.

As described above, the pair of connectors 2140, the heater 2120, and the power supply may electrically form a closed loop. The heater 2120 which is an electrical resistor may heat the aerosol generating article 2 accommodated in the insertion space 1100i while generating heat according to the flow of current.

In this regard, the pair of connectors 2140 may be electrically conductive materials and electrical resistors. Accordingly, when current flows through the pair of connectors 2140 to supply power to the heater 2120, heat may be generated unintentionally from the pair of connectors 2140. The heat generated from the pair of connectors 2140 may cause problems such as deformation of a peripheral structure. Therefore, an appropriate heat management of the pair of connectors 2140, such as dissipating or cooling heat, is required.

According to another embodiment, the pair of connectors 2140 may be withdrawn between the supporter 2110 and the inner wall 2131 of the insulator 2130. Because the pair of connectors 2140 start from the heater 2120 disposed in an inner surface of the supporter 2110, each of the pair of connectors 2140 may include a portion extending in a direction (e.g., a y-axis direction) across a longitudinal direction of the insertion space 1100i so as to be withdrawn to the outside of the supporter 2110.

At least a part of the pair of connectors 2140 may be disposed in the separation space 2125 between the supporter 2110 and the inner wall 2131 of the insulator 2130. As described above, because the separation space 2125 is simply filled with air or is a movement passage through which air is capable of moving, the pair of connectors 2140 may be naturally cooled through air present in the separation space 2125. However, hereinafter, an embodiment in which the separation space 2125 is used as the movement passage of air will be mainly described.

In this regard, heat emitted from the pair of connectors 2140 may escape to the outside of the heater assembly 2000 through the upper cover 2220 or the lower cover 2230 to which heat is transferred relatively well compared to peripheral components, or through the aerosol generating article 2 according to the movement of air.

In addition, in order for the pair of connectors 2140 to be disposed in the separation space 2125, a sufficient space needs to be secured between the supporter 2110 and the insulator 2130. In this regard, when the portion of the pair of connectors 2140 extending in the direction across the longitudinal direction of the insertion space 1100i is designed to be longer, the supporter 2110 and the insulator 2130 may be further away from each other.

As the supporter 2110 and the insulator 2130 is further away from each other, a larger amount of air may be filled in the separation space 2125, thereby improving the insulation performance. Accordingly, it may be more difficult to transfer heat to side parts of the housing 1100.

Meanwhile, the pair of connectors 2140 may be withdrawn from an upper side of the supporter 2110 to the separation space 2125. Specifically, the pair of connectors 2140 may be withdrawn to the separation space 2125 through an extra space between the supporter 2110 and the upper cover 2220 beyond an upper end of the supporter 2110. In this regard, the upper cover 2220 may include a groove in a direction toward the supporter 2110, and the groove may serve as the extra space between the supporter 2110 and the upper cover 2220.

When the pair of connectors 2140 extend toward a lower portion of the heater assembly 2000 so as to be connected to the power supply located in a lower side of the heater assembly 2000, the pair of connectors 2140 withdrawn through an upper side of the supporter 2110 may extend long along the separation space 2125. In this regard, because the power supply is located outside the heater assembly 2000, the pair of connectors 2140 may pass through the lower cover 2230 and extend a portion where the power supply is disposed.

Compared to when the pair of connectors 2140 are withdrawn through the lower side of the supporter 2110, the pair of connectors 2140 may occupy a larger region in the separation space 2125 when the pair of connectors 2140 are withdrawn through the upper side of the supporter 2110. In view of dissipating the heat generated from the pair of connectors 2140, such an arrangement may allow the separation space 2125 to be maximally utilized.

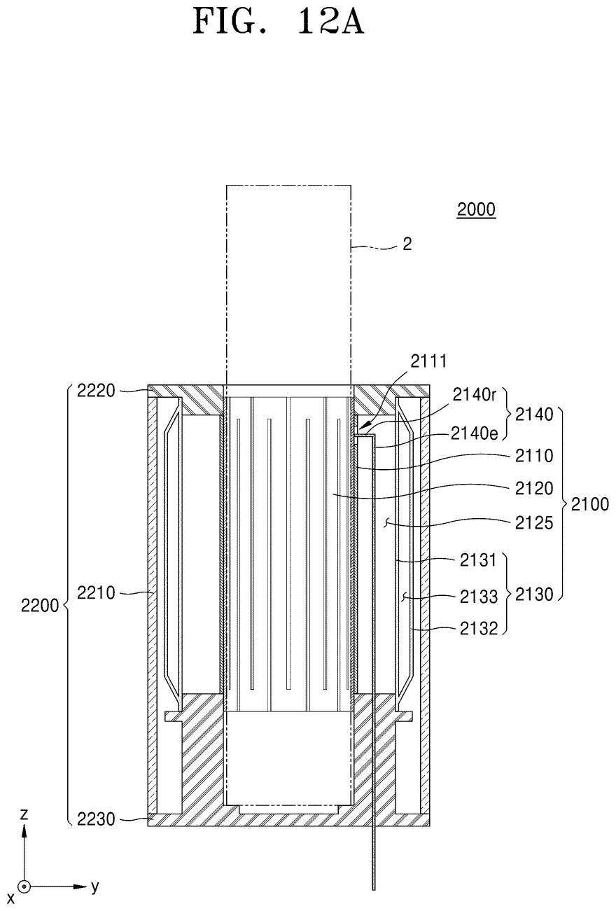

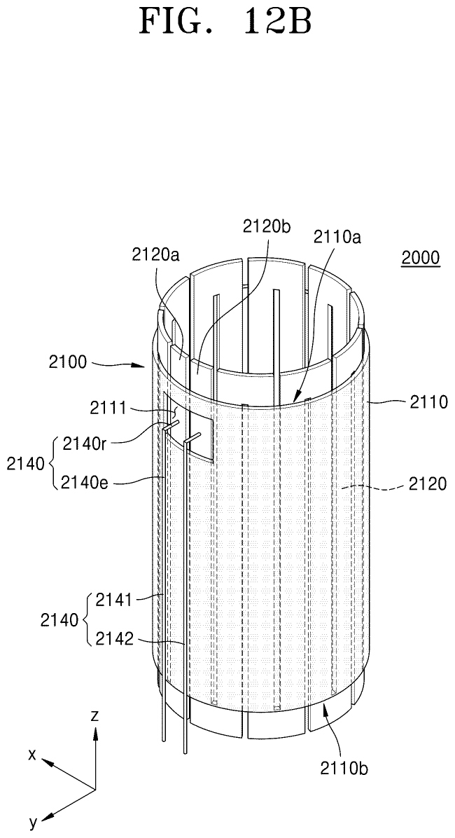

FIG. 12A is a cross-sectional view of another example of the heater assembly 2000 according to another embodiment. FIG. 12B is a perspective view illustrating an internal structure of the heater assembly 2000 illustrated in FIG. 12A.

In this regard, as shown in FIG. 11, FIG. 12A is the cross-sectional view of the heater assembly 2000 taken along the same cross-sectional line as the cross-sectional line A-A′ shown in FIG. 5A, and for simplification of the drawing, an inflow passage of the upper cover 2220 and a transfer passage of the lower cover 2230 are omitted.

Referring to FIGS. 12A and 12B, the heater assembly 2000 according to another embodiment may include the inner assembly 2100 and the outer assembly 2200. Detailed descriptions of the configuration and effects of the heater assembly 2000 which are redundant with those described above will be omitted.

As described above, the heater 2120 may have a specific pattern by which the one end 2120a and the other end 2120b are distinguished from each other. Referring to FIG. 12B, the one end 2120a and the other end 2120b of the heater 2120 may be respectively connected to the pair of connectors 2140. For example, the one end 2120a of the heater 2120 may be connected to the first connector 2141, and the other end 2120b of the heater 2120 may be connected to the second connector 2142. Accordingly, current may flow from a power supply to the heater 2120 through the first connector 2141, and flow back to the power supply through the second connector 2142 after flowing along the pattern of the heater 2120.

According to another embodiment, the pair of connectors 2140 may extend to the outside of the supporter 2110 through the through hole 2111. Specifically, the pair of connectors 2140 may include a first portion 2140r extending to penetrate the supporter 2110 and a second portion 2140e extending in a longitudinal direction of the supporter 2110. In this regard, the second portion 2140e may extend in the longitudinal direction of the supporter 2110 through the through hole 2111 and face toward both electrodes of the power supply so as to be connected to the power supply located in a lower side of the heater assembly 2000.

The through hole 2111 may be disposed in an upper region of the supporter 2110. In other words, the through hole 2111 may be disposed adjacent to the upper end 2110a of the supporter 2110. In view of dissipating heat generated from the pair of connectors 2140, the separation space 2125 may be fully utilized when the through hole 2111 is disposed adjacent to the upper end 2110a rather than the lower end 2110b of the supporter 2110.

However, the embodiment is not limited thereto, and the through hole 2111 may be disposed adjacent to the lower end 2110b of the supporter 2110. Even in this case, the separation space 2125 may be fully utilized according to a direction in which the pair of connectors 2140 extend.

In addition, even when the pair of connectors 2140 are not withdrawn through an open upper side of the supporter 2110, because the pair of connectors 2140 may be withdrawn through the through hole 2111 disposed in the upper region of the supporter 2110, the separation space 2125 may still be fully utilized in view of dissipating the heat generated from the pair of connectors 2140.

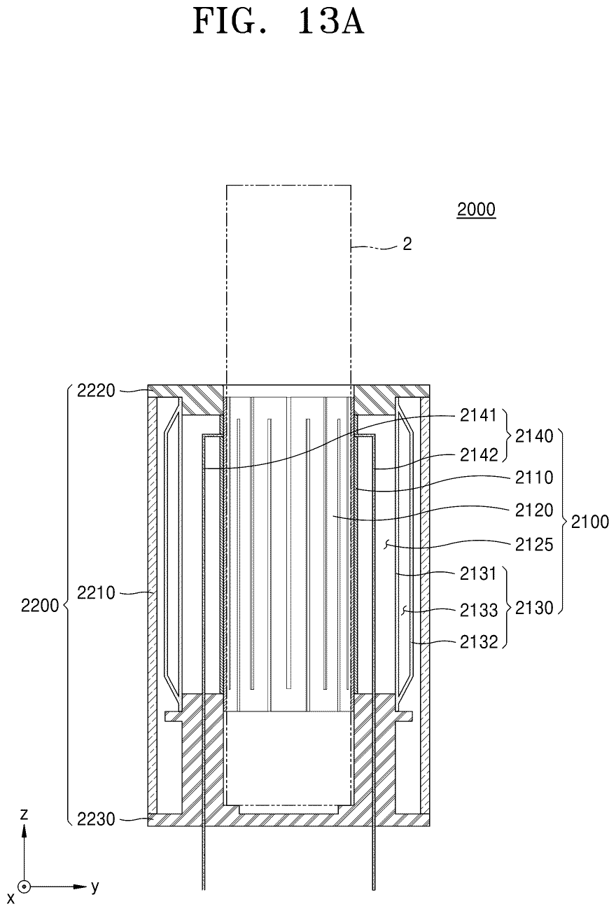

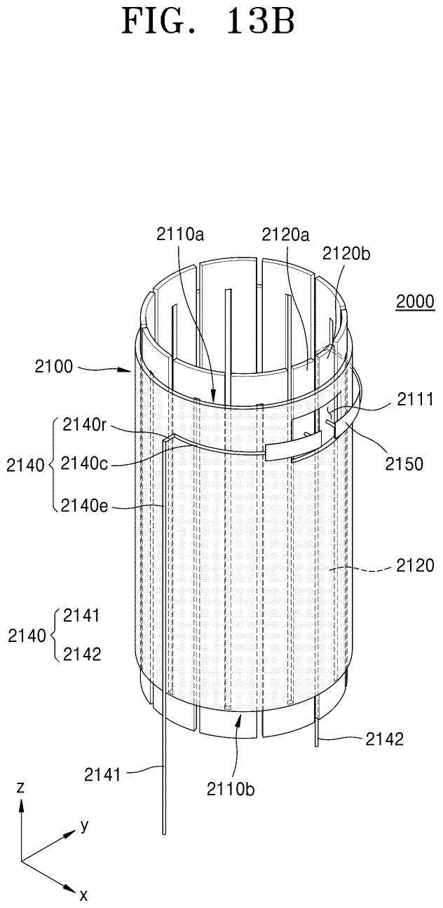

FIG. 13A is a cross-sectional view of the heater assembly 2000 according to another embodiment. FIG. 13B is a perspective view illustrating an internal structure of the heater assembly 2000 illustrated in FIG. 13A.

In this regard, as shown in FIG. 11, FIG. 1eA is the cross-sectional view of the heater assembly 2000 taken along the same cross-sectional line as the cross-sectional line A-A′ shown in FIG. 5A, and for simplification of the drawing, an inflow passage of the upper cover 2220 and a transfer passage of the lower cover 2230 are omitted.

Referring to FIGS. 13A and 13B, the heater assembly 2000 according to another embodiment may include the inner assembly 2100 and the outer assembly 2200. Detailed descriptions of the configuration and effects of the heater assembly 2000 which are redundant with those described above will be omitted.

As described with reference to FIG. 7, the first connector 2141 and the second connector 2142 located outside the supporter 2110 may extend in different directions so as to be further away from each other. For example, a portion of at least one of the pair of connectors 2140 may surround an outer side of the supporter 2110.

In this regard, the portion of the pair of connectors 2140 extending in a circumferential direction of the supporter 2110 so as to surround the outer side of the supporter 2110 may be referred to as a third portion 2140c. That is, the pair of connectors 2140 may include the third portion 2140c together with the first portion 2140r and the second portion 2140e described above.

Both ends of the third portion 2140c may be connected to the first portion 2140r and the second portion 2140e, respectively, to connect the first portion 2140r to the second portion 2140e.

Meanwhile, a direction in which the first connector 2141 extends and a direction in which the second connector 2142 extends may vary according to the embodiment. Unlike the structure shown in FIG. 7, as shown, the first connector 2141 may extend in a first direction surrounding the supporter 2110 in the separation space 2125 between the supporter 2110 and the inner wall 2131 of the insulator 2130, and the second connector 2142 may extend in a second direction opposite to the first direction.

In this regard, the first connector 2141 and the second connector 2142 may extend to surround about ¼ of an outer circumference of the supporter 2110 through the third portion 2140c. Accordingly, the first connector 2141 and the second connector 2142 may extend in the longitudinal direction of the supporter 2110 from opposite sides with the supporter 2110 disposed therebetween to face the other electrode of a power supply.

Even when the pair of connectors 2140 are disposed adjacent to each other in a portion connected to the heater 2120, because the first connector 2141 and the second connector 2142 extend toward the power supply located in a lower side of the heater assembly 2000 at a position away from each other, a phenomenon in which the pair of connectors 2140 are entangled or twisted with each other may be prevented.

On the other hand, even when the pair of connectors 2140 is as long as the third portion 2140c, because the third portion 2140c is disposed inside the separation space 2125, a region where the pair of connectors 2140 are in contact with air filled in the separation space 2125 increases. Therefore, the pair of connectors 2140 may be cooled more rapidly.

According to another embodiment, the fixer 2150 may be used to couple at least one of the pair of connectors 2140 to the supporter 2110.

As shown, the fixer 2150 may couple or attach a portion (e.g., the third portion 2140c) of the first connector 2141 and the second connector 2142 extending in the circumferential direction of the supporter 2110 to the outside of the supporter 2110. Although not shown, the fixer 2150 may also be applied to the second portion 2140e extending in the longitudinal direction of the supporter 2110.

According to the embodiment, the supporter 2110 may include a structure that may be coupled to the pair of connectors 2140. In this case, the pair of connectors 2140 may remain coupled to the supporter 2110 without the separate fixer 2150.

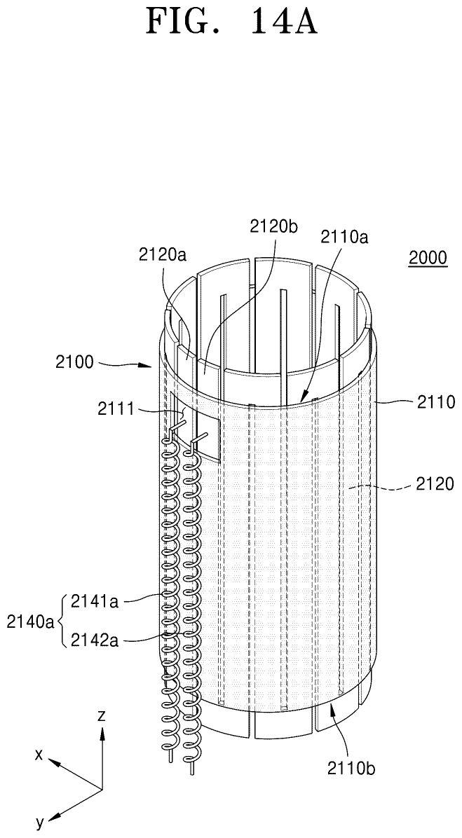

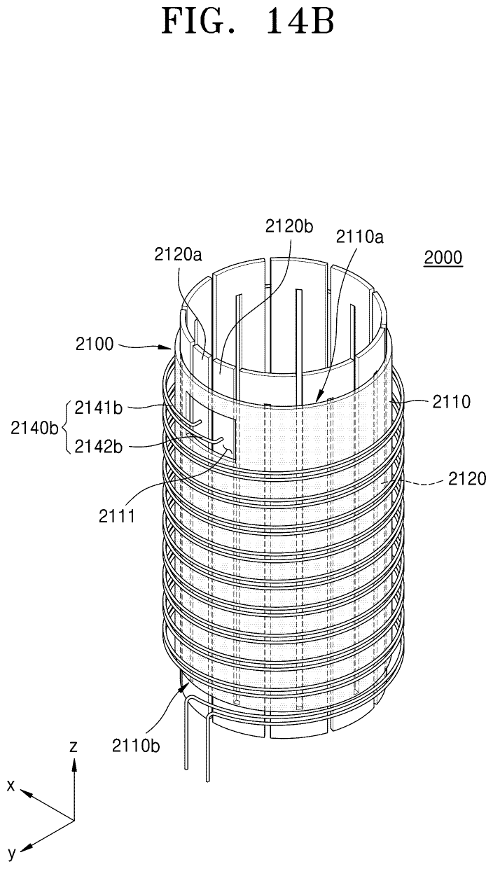

FIGS. 14A and 14B are each a perspective view illustrating another example of an internal structure of the heater assembly 2000 according to another embodiment.

Referring to FIGS. 14A and 14B, some components of the inner assembly 2100 forming the heater assembly 2000 according to another embodiment is illustrated. As shown, the inner assembly 2100 may include the supporter 2110, the heater 2120, and a pair of connectors 2140a and 2140b. Detailed descriptions of the configuration and effects of the heater assembly 2000 which are redundant with those described above will be omitted.

According to another embodiment, each of the pair of connectors 2140a and 2140b may have a shape with a relatively large heat dissipation area. For example, at least one of the pair of connectors 2140a and 2140b may include a helical structure.

Referring to FIG. 14A, each of the first connector 2141a and the second connector 2142a may include the helical structure. In this regard, the first connector 2141a and the second connector 2142a may include the helical structure in a spring shape extending in one direction.

Referring to FIG. 14B, each of the first connector 2141b and the second connector 2142b may include the helical structure. In this regard, the first connector 2141b and the second connector 2142b may be disposed to surround an outer side of the supporter 2110 along the helical structure.

Because the pair of connectors 2140a and 2140b according to the above-described structure are difficult to be entangled or twisted with each other, the heating performance or heating efficiency of the heater 2120 may be maintained in the best state. In addition, according to the above-described structure, the pair of connectors 2140a and 2140b may occupy a wider separation space while remaining no contact with each other. As the heat dissipation area of the pair of connectors 2140a and 2140b increases, the contact area between the pair of connectors 2140a and 2140b and air in a separation space (e.g., the separation space 2125 of FIG. 11) formed outside the supporter 2110 may increase, and as a result, the pair of connectors 2140a and 2140b may be cooled more rapidly.

According to the heater assembly 2000 and the aerosol generating device 1 including the same according to embodiments, the heating performance or heating efficiency of the heater 2120 may be maintained in the best state without being degraded.

In addition, according to the heater assembly 2000 and the aerosol generating device 1 including the same according to the embodiments, the internal components of the heater assembly 2000 may be protected from high heat. Specifically, the pair of connectors 2140 that generate heat may be withdrawn to the separation space 2125 and cooled through the air filled in the separation space 2125, and thus the internal components of the heater assembly 2000 may be protected from the high heat emitted by the pair of connectors 2140.

In addition, according to the heater assembly 2000 and the aerosol generating device 1 including the same according to the embodiments, heat generated inside the heater assembly 2000 may be efficiently used without leaving the inside of the aerosol generating device 1 due to various components constituting the heater assembly 2000.

In addition, according to the heater assembly 2000 and the aerosol generating device 1 including the same according to the embodiments, the limited space inside the aerosol generating device 1 may be efficiently used due to a compact structure of the heater assembly 2000.

Certain embodiments or other embodiments of the present disclosure described above are not exclusive or distinct from each other. The certain embodiments or other embodiments of the present disclosure described above may be combined with each other or used in combination with each other in their respective components or functions.

For example, it means that an A component described in a specific embodiment and/or the drawings and a B component described in another embodiment and/or the drawings may be combined with each other. In other words, even when it is not explained directly about combination between components, it is possible to combine unless it is explained that combination is impossible.

The above detailed description should not be interpreted restrictedly but should be considered illustrative in all aspects. The scope of the present disclosure should be determined by a rational interpretation of the attached claims, and all changes within the equivalent scope of the present disclosure are included in the scope of the present disclosure.

According to a heater assembly and an aerosol generating device including the same according to embodiments, heating performance or heating efficiency of a heater may be maintained in the best state without being degraded.

In addition, according to the heater assembly and the aerosol generating device including the same according to embodiments, heat generated inside the heater assembly may be efficiently used without leaving the inside of the aerosol generating device.

In addition, according to the heater assembly and the aerosol generating device including the same according to embodiments, a limited space inside the aerosol generating device may be efficiently used.

Effects of the present disclosure are not limited to the above effects, and effects that are not mentioned could be clearly understood by one of ordinary skill in the art from the present specification and the attached drawings.

What is claimed is:

1. A heater assembly for an aerosol generating device, the heater assembly comprising:
a supporter comprising an insertion space accommodating an aerosol generating article;
a heater disposed on an inner surface of the supporter surrounding the insertion space;
an insulator comprising an inner wall spaced apart by a certain distance from an outer surface of the supporter to surround the supporter, an outer wall spaced apart at least partially from the inner wall, and an insulation space in a vacuum state formed between the inner wall and the outer wall; and
a pair of connectors electrically connected to the heater to supply power to the heater,
wherein the supporter comprises, in at least one region, a through hole that is opened to face the insertion space so that the pair of connectors are exposed to an outside of the supporter.

2. The heater assembly of claim 1, wherein
the heater includes a pattern by which one end and the other end are distinguished from each other, and
the one end of the heater is connected to one of the pair of connectors, and the other end of the heater is connected to the other one of the pair of connectors.

3. The heater assembly of claim 2, wherein
the heater is disposed to surround at least a part of the insertion space, and
the one end of the heater and the other end of the heater are disposed adjacent to each other and extend in parallel.

4. The heater assembly of claim 3, wherein
the one end of the heater and the other end of the heater extend toward a lower side of the heater, and
the through hole is disposed in a lower region of the supporter.

5. The heater assembly of claim 1, wherein
the pair of connectors extend to the outside of the supporter through the through hole, and
one of the pair of connectors and the other one of the pair of connectors extend in different directions so as to be away from each other.

6. The heater assembly of claim 5, wherein a portion of at least one of the pair of connectors surrounds an outer side of the supporter.

7. The heater assembly of claim 6, wherein the portion surrounding the outer side of the supporter has a curved shape surrounding the outer surface of the supporter.

8. The heater assembly of claim 7, wherein a length of the portion in a longitudinal direction of the supporter is about 30 % to about 100 % of a length of the supporter.

9. The heater assembly of claim 1, wherein one of the pair of connectors is electrically connected to the ground at the outside of the supporter.

10. The heater assembly of claim 1, further comprising: a fixer configured to couple at least one of the pair of connectors to an outer side of the supporter.

11. The heater assembly of claim 1, further comprising: a conductor electrically connected to at least one of the pair of connectors and surrounding the outer surface of the supporter.

12. The heater assembly of claim 1, wherein the supporter includes an electrically conductive material, and is insulated so as to be electrically insulated from the heater.

13. The heater assembly of claim 1, wherein a separation space between the supporter and the inner wall of the insulator is fluidly connected to one end of the aerosol generating article accommodated in the insertion space.

14. An aerosol generating device comprising:
the heater assembly of claim 1;
an output unit configured to output information about a state of the aerosol generating device; and
a control unit electrically connected to the output unit,
wherein the control unit is configured to determine whether the supporter and the heater have been electrically connected to each other based on a change in electric characteristics of the heater, and, when it is determined that the supporter and the heater have been electrically connected to each other, provide a notification to a user through the output unit.

15. The aerosol generating device of claim 14, wherein the control unit is further configured to control a temperature of the heater based on the change in the electrical characteristics of the heater.
